(19) United States
(12) Patent Application Publication
(10) Pub. No.: US 2012/0231234 A1
(43) Pub. Date: Sep. 13, 2012

(54) CURABLE COMPOSITION FOR IMPRINTS, PATTERNING METHOD AND PATTERN

(75) Inventor: Kunihiko KODAMA, Haibara-gun (JP)

(73) Assignee: FUJIFILM Corporation, Tokyo (JP)

(21) Appl. No.: 13/413,184

(22) Filed: Mar. 6, 2012

(30) Foreign Application Priority Data
Mar. 7, 2011 (JP) 2011-049095

(51) Int. Cl. C08J 3/24; C08J 3/28; B32B 3/14; B05D 3/06

(52) U.S. Cl. 428/195.1; 427/510; 522/108; 522/99

(57) ABSTRACT

Provided is a curable composition for imprints which ensures satisfactory pattern formability and defect-preventive performance even in the process of high-speed pattern transfer. The curable composition for imprints, comprises at least one species of polymerizable monomer(s) (A), and a photo-polymerization initiator (B), wherein the polymerizable monomer (A) contains a polymerizable monomer (Ax) having a hydrogen-bondable group and fluorine-containing group(s).

### CROSS-REFERENCE TO RELATED APPLICATIONS

The present application claims the benefit of priority from Japanese Patent Application No. 049095/2011 filed on Mar. 7, 2011, the contents of which are herein incorporated by reference in their entirety.

### BACKGROUND OF THE INVENTION

1. Field of the Invention

The present invention relates to a method for producing a curable composition for imprints, a patterning method, and a device for producing a curable composition for imprints.

More precisely, the invention relates to a method for producing a curable composition for patterning through photo-irradiation to give imprints, which is used in producing magnetic recording media such as semiconductor integrated circuits, flat screens, micro electromechanical systems (MEMS), sensor devices, optical discs, high-density memory discs, etc.; optical members such as gratings, relief holograms, etc.; optical films for production of nanodevices, optical devices, flat panel displays, etc.; polarizing elements, thin-film transistors in liquid-crystal displays, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

2. Description of the Related Art

Nanoimprint technology is a development advanced from embossing technology well known in the art of optical disc production, which comprises pressing a mold original with an embossed pattern formed on its surface (this is generally referred to as “mold”, “stamper” or “template”) against a resin to thereby accurately transfer the micropattern onto the resin through mechanical deformation of the resin. In this, when a mold is once prepared, then microstructures such as nanostructures can be repeatedly molded, and therefore, this is economical, and in addition, harmful wastes and discharges from this nanotechnology are reduced. Accordingly these days, this is expected to be applicable to various technical fields.

Two methods of nanoimprint technology have been proposed; one is a thermal nanoimprint method using a thermoplastic resin as the material to be worked (for example, see S. Chou, et al., Appl. Phys. Lett. Vol. 67, 3114 (1995)), and the other is a photonanoimprint method using a curable composition (for example, see M. Colbun, et al., Proc. SPIE, Vol. 3676, 379 (1999)). In the thermal nanoimprint method, a mold is pressed against a polymer resin heated up to a temperature not lower than the glass transition temperature thereof, then the resin is cooled and thereafter released from the mold to thereby transfer the microstructure of the mold onto the resin on a substrate. The method is applicable to various resin materials and glass materials and is expected to be applicable to various fields. For example, U.S. Pat. Nos. 5,772,905 and 5,956,216 disclose a nanoimprint method of forming nanopatterns inexpensively.

On the other hand, in the photonanoimprint method where a curable composition for photonanoimprints is photo-cured by photo-irradiation through a transparent mold or a transparent substrate, the transferring material does not require heating in pressing it against the mold, and therefore the method enables room-temperature imprinting. Recently, new developments having the advantages of the above two as combined, have been reported, including a nanocasting method and a reversal imprint method for forming three-dimensional structures.

For the nanoimprint methods as above, proposed are applied technologies mentioned below.

In the first technology, the molded pattern itself has a function, and is applied to various elements in nanotechnology and to structural members. Its examples include various micro/nano optical elements and high-density recording media, as well as structural members in optical films, flat panel displays, etc. The second technology is for hybrid-molding of microstructures and nanostructures, or for construction of laminate structures through simple interlayer positioning, and this is applied to production of μ-TAS (micro-total analysis system) and biochips. In the third technology, the formed pattern is used as a mask and is applied to a method of processing a substrate through etching or the like. In these technologies, high-precision positioning is combined with high-density integration; and in place of conventional lithography technology, these technologies are being applied to production of high-density semiconductor integrated circuits and transistors in liquid-crystal displays, and also to magnetic processing for next-generation hard discs referred to as patterned media. Recently, the action on industrialization of the above-mentioned nanoimprint technologies and their applied technologies has become active for practical use thereof.

As one example of nanoimprint technology, hereinunder described is an application to production of high-density semiconductor integrated circuits. The recent development in micropatterning and integration scale enlargement in semiconductor integrated circuits is remarkable, and high-definition photolithography for pattern transfer for realizing the intended micropatterning is being much promoted and advanced in the art. However, for further requirement for more definite micropatterning to a higher level, it is now difficult to satisfy all the three of micropattern resolution, cost reduction and throughput increase. Regarding this, as a technology of micropatterning capable of attaining at a low cost, nanoimprint lithography (photonanoimprint method) is proposed. For example, U.S. Pat. Nos. 5,772,905 and 5,259,926 disclose a nanoimprint technology of using a silicon wafer as a stamper for transferring a microstructure of at most 25 nm. This application requires micropatternability on a level of a few tens nm and high-level etching resistance of the micropattern functioning as a mask in substrate processing.

An application example of nanoimprint technology to production of next-generation hard disc drives (HDD) is described. HDD has realized increased large-scale capacity as a result of the increase in the surface-recording density thereon. However, in increasing the recording density, there occurs a problem of so-called magnetic field expansion from the side surface of the magnetic head. The magnetic field expansion could not be reduced more than a certain level even though the size of the head is reduced, therefore causing a phenomenon of so-called sidelight. The sidelight, if any, may cause erroneous writing on the adjacent tracks and may erase the already recorded data. In addition, owing to the magnetic field expansion, there may occur another problem in that superfluous signals may be read from the adjacent track in reproduction. To solve these problems, there are proposed technologies of discrete track media and bit patterned media of filling the distance between the adjacent tracks with a non-magnetic material to thereby physically and magnetically separate the tracks. As a method of forming the magnetic or non-magnetic pattern in production of these media, application of nanoimprint technology is proposed. The application also requires micropatternability on a level of a few tens nm and high-level etching resistance of the micropattern functioning as a mask in substrate processing.

Next described is an application example of nanoimprint technology to flat displays such as liquid-crystal displays (LCD) and plasma display panels (PDP).

With the recent tendency toward large-sized LCD substrates and PDP substrates for high-definition microprocessing thereon, photonanoimprint lithography has become specifically noted these days as an inexpensive lithography technology capable of being substituted for conventional photolithography for use in production of thin-film transistors (TFT) and electrode plates. Accordingly, it has become necessary to develop a photo-curable resist capable of being substituted for the etching photoresist for use in conventional photolithography.

Further, for the structural members for LCD and others, application of photonanoimprint technology to transparent protective film materials described in JP-A-2005-197699 and 2005-301289, or to spacers described in JP-A-2005-301289 is being under investigation. Differing from the above-mentioned etching resist, the resist for such structural members finally remains in displays, and therefore, it may be referred to as “permanent resist” or “permanent film”.

The spacer to define the cell gap in liquid-crystal displays is also a type of the permanent film; and in conventional photolithography, a photo-curable composition comprising a resin, a photopolymerizable monomer and an initiator has been generally widely used for it (for example, see JP-A-2004-240241). In general, the spacer is formed as follows: After a color filter is formed on a color filter substrate, or after a protective film for the color filter is formed, a photocurable composition is applied onto, and a pattern having a size of from 10 μm or 20 μm or so is formed through photolithography, and this is further thermally cured through past-baking to form the intended spacer.

Nanoimprint technology is also applicable to production of an anti-reflective structure generally called “moth eye”. The anti-reflective structure may be obtained by forming, by a pitch smaller than wavelength of light, numerous micro-irregularities composed of a transparent material on a transparent mold product, so as to vary the refractive index in the thickness-wise direction. Since this sort of anti-reflective structure has the refractive index continuously varying in the thickness-wise direction, so that there is no refractive index discontinuity, and the structure is theoretically non-reflective. In addition, since the structure has only a small wavelength dependence and a high anti-reflective performance against oblique incident light, so that the anti-reflective performance thereof is superior to that of multi-layered, anti-reflective film.

Further, nanoimprint lithography is useful also in formation of permanent films in optical members such as microelectromechanical systems (MEMS), sensor devices, gratings, relief holograms, etc.; optical films for production of nanodevices, optical devices, flat panel displays, etc.; polarizing elements, thin-film transistors in liquid-crystal displays, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

In application to such permanent films, the formed pattern remains in the final products, and is therefore required to have high-level properties of mainly film durability and strength, including heat resistance, light resistance, solvent resistance, scratch resistance, high-level mechanical resistance to external pressure, hardness, etc.

Almost all patterns heretofore formed in conventional photolithography can be formed in nanoimprint technology, which is therefore specifically noted as a technology capable of forming micropatterns inexpensively.

From the viewpoint of industrial applicability, nanoimprint technology is required to ensure not only satisfactory pattern formability, but also application-specific characteristics as described in the above, and still also high productivity.

JP-A-2006-310565 and JP-A-2008-95037 disclose that photo-curable compositions which contain fluorine-containing monomers showed good pattern formability when applied to nanoimprinting. However, even with these compositions, problems remained to be solved in that the pattern formability and defect-preventive performance may degrade in high-speed pattern transfer, and in that surface irregularities on the side faces of etched patterns, or so-called line edge roughness, may increase when applied to substrate processing.

Other known curable compositions for imprinting include those disclosed in J JP-A-2006-310565 and JP-A-2010-239121, without any description or suggestion on their performances in high-speed pattern transfer.

### SUMMARY OF THE INVENTION

It is therefore an object of the present invention to solve the above-described problems, and to provide a curable composition for imprints, which ensures satisfactory pattern formability and defect-preventive performance even in the process of high-speed pattern transfer. It is another object of the present invention to provide a curable composition for imprints, which causes less line edge roughness after etching when applied to substrate processing. It is still another object of the present invention to provide a method of forming a pattern using the curable composition for imprints, and a pattern obtained by the method of forming a pattern.

From our extensive investigations aimed at solving the above-described problems, the present inventors found out that a curable composition for imprints, which ensures a satisfactory pattern formability, causative of minimum defects, and capable of suppressing line edge roughness after etching when applied to substrate processing may be obtained, by using a polymerizable monomer having a hydrogen-bondable group and fluorine-containing group(s), and completed the present invention. More specifically, the object described in the above was achieved by the invention below.

(1) A curable composition for imprints, comprising at least one species of polymerizable monomer(s) (A), and a photo-polymerization initiator (B), wherein the polymerizable monomer (A) contains a polymerizable monomer (Ax) having a hydrogen-bondable group and fluorine-containing group(s).

(2) The curable composition for imprints according to (1), wherein the polymerizable monomer (Ax) has one fluorine-containing group.

(3) The curable composition for imprints according to (1) or (2), wherein the fluorine-containing group owned by the polymerizable monomer (Ax) is a perfluoroalkyl group having 4 to 6 carbon atoms.

(4) The curable composition for imprints according to any one of (1) to (3), wherein the hydrogen-bondable group owned by the polymerizable monomer (Ax) has a N—H bond and/or an O—H bond.

(5) The curable composition for imprints according to any one of (1) to (4), wherein the polymerizable monomer (Ax) has one polymerizable group.

(6) The curable composition for imprints according to any one of (1) to (5), wherein the polymerizable monomer (Ax) has an acryloyloxy group (CH₂═CHC(═O)O—).

(7) The curable composition for imprints according to any one of (1) to (6), wherein the polymerizable monomer (A) comprises another polymerizable monomer different from the polymerizable monomer (Ax).

(8) The curable composition for imprints according to (7), wherein the polymerizable monomer different from the polymerizable monomer (Ax) is a (meth)acrylate comprising at least one of aromatic group, alicyclic hydrocarbon group and Si atom.

(9) The curable composition for imprints according to any one of (1) to (8), wherein the content of the polymerizable monomer (Ax) is 0.2 to 10% by mass of the total polymerizable monomer components.

(10) The curable composition for imprints according to any one of (1) to (9), further comprising a polymerization inhibitor.

(11) The curable composition for imprints according to any one of (1) to (10), wherein the fluorine-containing group includes at least one of partial structures represented by the formula (I-1) or (I-2):

—X—Rf (I-1)

—X—Rf—X— (I-2)

wherein X represents an alkylene group having 1 to 6 carbon atoms wherein X represents an alkylene group having 1 to 6 carbon atoms and Rf represents a fluoroalkyl group or fluoroalkyl ether group.

(12) The curable composition for imprints according to any one of (1) to (10), wherein the fluorine-containing group includes at least one of partial structures represented by the formula (II-1) or (II-2):

—X—CₙF₂ₙ₊₁ (II-1)

—X—CₙF₂ₙ—X— (II-2)

wherein X represents an alkylene group having 1 to 6 carbon atoms and n represents an integer from 1 to 8.

(13) The curable composition for imprints according to any one of (1) to (12), wherein the hydrogen-bondable group has a partial structure represented by —OH, —C(═O)OH, —SO₃H, —NH—, —NH₂, —NHC(O)—, —NHC(O)O—, —NHC(O)NH—, —SO₂NH—, —SO₂NHC(═O)— or —SO₂NHSO₂—.

(14) The curable composition for imprints according to any one of (1) to (13), wherein the polymerizable monomer (A) is selected from compounds represented by any one of the following formulae:

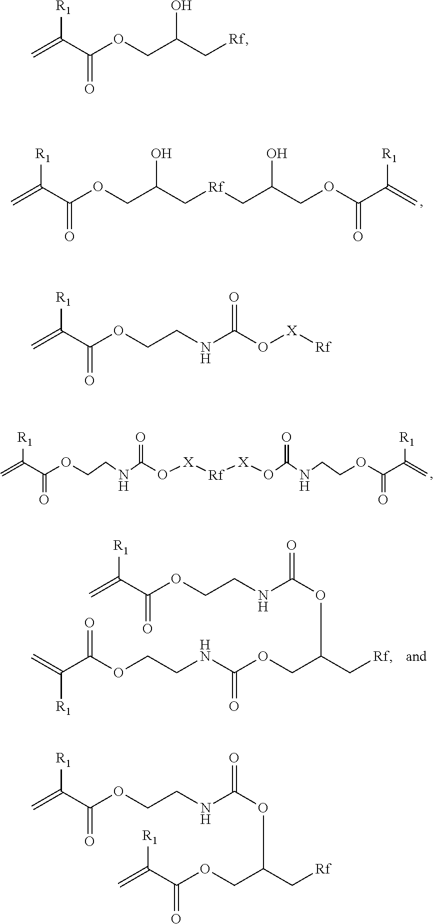

wherein R₁ independently represents a hydrogen atom, halogen atom, alkyl group or cyano group, Rf represents a fluorine-containing group and X represents an alkylene group having 1 to 6 carbon atoms.

(15) The curable composition for imprints according to (14), wherein Rf is a perfluoroalkyl group.

(16) The curable composition for imprints according to any one of (1) to (15), wherein the polymerizable monomer (A) has a molecular weight of 300 to 2000.

(17) The curable composition for imprints according to any one of (7) to (16), wherein the content of the polymerizable monomer different from the polymerizable monomer (Ax) is 20 to 70% by mass of the total polymerizable monomer components.

(18) A method of forming a pattern, comprising:

forming a pattern-forming layer by applying the curable composition for imprints according to anyone of (1) to (17), onto a base;

pressing a mold against the surface of the pattern-forming layer; and

irradiating light to the pattern-forming layer.

(19) The method of forming a pattern according to (18), wherein the curable composition for imprints is applied onto the base by an ink-jet process.

(20) A pattern obtained by the method of forming a pattern according to (18) or (19).

By using the composition of the present invention, a curable composition for imprints which ensures a satisfactory pattern formability, causative of minimum defects, and capable of suppressing line edge roughness after etching when applied to substrate processing, may be provided.

### BEST MODE FOR CARRYING OUT THE INVENTION

The contents of the invention are described in detail hereinunder. In this description, the numerical range expressed by the wording “a number to another number” means the range that falls between the former number indicating the lowermost limit of the range and the latter number indicating the uppermost limit thereof.

In this description, “(meth)acrylate” means acrylate and methacrylate; “(meth)acrylic” means acrylic and methacrylic; “(meth)acryloyl” means acryloyl and methacryloyl. In the invention, monomer is differentiated from oligomer and polymer, and the monomer indicates a compound having a weight-average molecular weight of at most 1,000. In this description, “functional group” means a group participating in polymerization.

“Imprint” referred to in the invention is meant to indicate pattern transfer in a size of from 1 nm to 10 mm and preferably meant to indicate pattern transfer in a size of from about 10 nm to 100 μm (nanoimprint).

Regarding the expression of “group (atomic group)” in this description, the expression with no indication of “substituted” or “unsubstituted” includes both “substituted group” and “unsubstituted group”. For example, “alkyl group” includes not only an alkyl group not having a substituent (unsubstituted alkyl group) but also an alkyl group having a substituent (substituted alkyl group).

### [Curable Composition for Imprints of the Present Invention]

The curable composition for imprints of the present invention (also simply referred to as “curable composition of the present invention” or “composition of the present invention”, hereinafter) includes one or more species of polymerizable monomer(s) (A) and one or more species of photo-polymerization initiator(s) (B), and contains, as the polymerizable monomer, a polymerizable monomer (Ax) which has a hydrogen-bondable group and fluorine-containing group(s).

### Polymerizable Monomer (A)

### Polymerizable Monomer (Ax) Having Hydrogen-Bondable Group and Fluorine-Containing Group(s)

The polymerizable functional group owned by the polymerizable monomer (Ax) is exemplified by radical polymerizable groups such as CH(R¹)═CHC(═O)— (R¹ represents a hydrogen atom, alkyl group, halogen atom, or cyano group); and cation polymerizable groups such as epoxy group, oxetane group, and vinyl ether group, and is more preferably (meth)acryl group. The polymerizable monomer (Ax) preferably contains one or two, more preferably one, polymerizable group.

The fluorine-containing group owned by the polymerizable monomer (Ax) is preferably selected from fluoroalkyl group and fluoroalkyl ether group, where fluoroalkyl group is more preferable.

The fluoroalkyl group preferably has two or more carbon atoms, and more preferably 4 or more, whereas the upper limit thereof, although not specifically limited, is preferably 20 or less, more preferably 8 or less, and still more preferably 6 or less. A fluoroalkyl group which has 4 to 6 carbon atoms is most preferable. The fluoroalkyl group also includes a fluoroalkylene group in which the fluoroalkyl group configures a linking group. The fluoroalkyl group is preferably a perfluoroalkyl group, and is also preferably a straight-chain fluoroalkyl group.

The fluoroalkyl ether group preferably contains a perfluoroethyleneoxy group or perfluoropropyleneoxy group. The group preferably has a trifluoromethyl group structure at the terminal thereof, wherein preferable examples of which include a fluoroalkyl ether unit having a trifluoromethyl group such as —(CF(CF₃)CF₂O)—, and/or, a unit having a trifluoromethyl group at the terminal of the fluoroalkyl ether group.

The fluoroalkyl ether group also includes a fluoroalkyl ether linking group in which the fluoroalkyl ether group configures a linking group.

The fluoroalkyl ether group preferably has 4 to 20 carbon atoms, and more preferably 4 to 15 carbon atoms.

More preferable examples of the fluorine-containing group include the partial structures represented by the formula (I-1) or (I-2), and more preferably by the formula (II-1) or (II-2). By adopting the monomer having this sort of partial structure, the composition may be excellent in the pattern formability, and improved in the time-dependent stability.

—X—Rf (I-1)

—X—Rf—X— (I-2)

—X—CₙF₂ₙ₊₁ (II-1)

—X—CₙF₂ₙX— (II-2)

In the formula, X represents an alkylene group having 1 to 6 carbon atoms, which may have thereon a substituent, but preferably have no substituent. Preferable examples of the substituent on the alkylene group include alkyl group, fluoroalkyl group, and a substituent having a hydrogen-bondable group described later. Rf represents a fluoroalkyl group or fluoroalkyl ether group.

n represents an integer from 1 to 8, and preferably 4 to 6.

The number of the fluorine-containing groups which reside in the polymerizable monomer (Ax) is preferably 1 to 3 from the viewpoint of compatibility with the other components, more preferably one or two, and still more preferably one. The total number of fluorine atoms owned by the polymerizable monomer (Ax) is preferably 3 to 60, more preferably 5 to 20, and still more preferably 9 to 20.

The polymerizable monomer (Ax) preferably has a ratio of fluorine content, defined as below, of 30 to 60%, more preferably 35 to 55%, and still more preferably 35 to 50%. By adjusting the ratio of fluorine content to an appropriate range, dirt on mold may be reduced, and line edge roughness after dry etching may be reduced.

Ratio of fluorine content=[{(number of fluorine atoms in one polymerizable monomer (A))×(atomic weight of fluorine atom)}/(molecular weight of polymerizable monomer (A))]×100

The hydrogen-bondable group preferably has a hydrogen atom capable of forming a hydrogen bond. The functional group, which has a hydrogen atom capable of forming hydrogen bond, preferably has an O—H bond or N—H bond, more preferably has a partial structure represented by —OH, —C(═O)OH, —SO₂H, —NH—, —NH₂, —NHC(O)—, —NHC(O)O—, —NHC(O)NH—, —SO₂NH—, —SO₂NHC(═O)— or —SO₂NHSO₂—, still more preferably —OH or —NHC(O)O—, and most preferably —OH.

The polymerizable monomer (Ax) used in the present invention is preferably composed only of a polymerizable group, a divalent linking group (preferably a group composed only of carbon atom(s), hydrogen atom(s) and oxygen atom(s), and more preferably a group composed of —CH₂—, —O—, —C(═O)—, and combinations of them), a hydrogen-bondable group, and a fluorine-containing group.

The polymerizable monomer (Ax) is preferably the polymerizable monomers represented by any one of the formulae below:

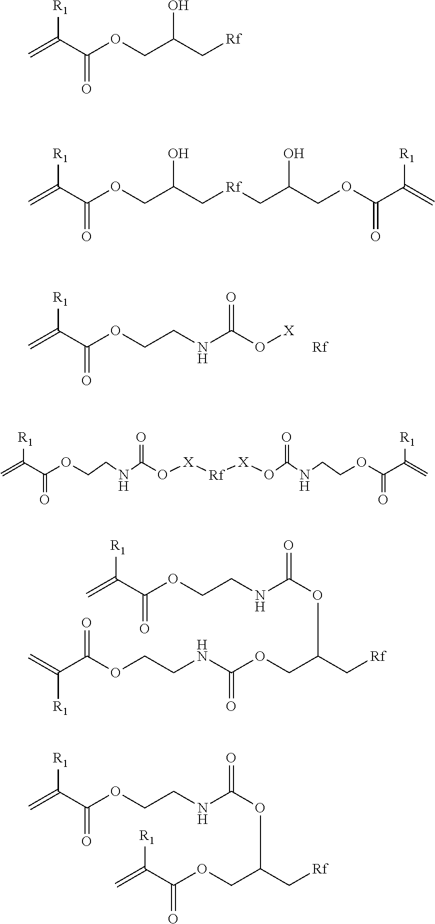

(In the formula, R₁ independently represents a hydrogen atom, halogen atom, alkyl group or cyano group, Rf represents a fluorine-containing group and X represents an alkylene group having 1 to 6 carbon atoms.)

Each R¹ preferably represents a hydrogen atom, alkyl group or cyano group, more preferably a hydrogen atom or alkyl group having 1 to 4 carbon atoms, particularly preferably a hydrogen atom or methyl group, and most preferably a hydrogen atom.

Examples of the halogen atom which composes R¹ include fluorine atom and chlorine atom.

Rf is preferably a perfluoroalkyl group, and more preferably a C₄₋₆ perfluoroalkyl group.

The polymerizable monomer (Ax) used in the present invention preferably has a molecular weight of 300 to 2000, more preferably 300 to 1000, and still more preferably 300 to 800. By adjusting the molecular weight in an appropriate range, the curable composition may be improved in the readiness of mold filling, and the defects may be reduced.

Specific examples of the polymerizable monomer (Ax) used for the curable composition of the present invention will be shown below, without limiting the present invention. In the formulae below, R¹ independently represents any of a hydrogen atom, alkyl group, halogen atom and cyano group.

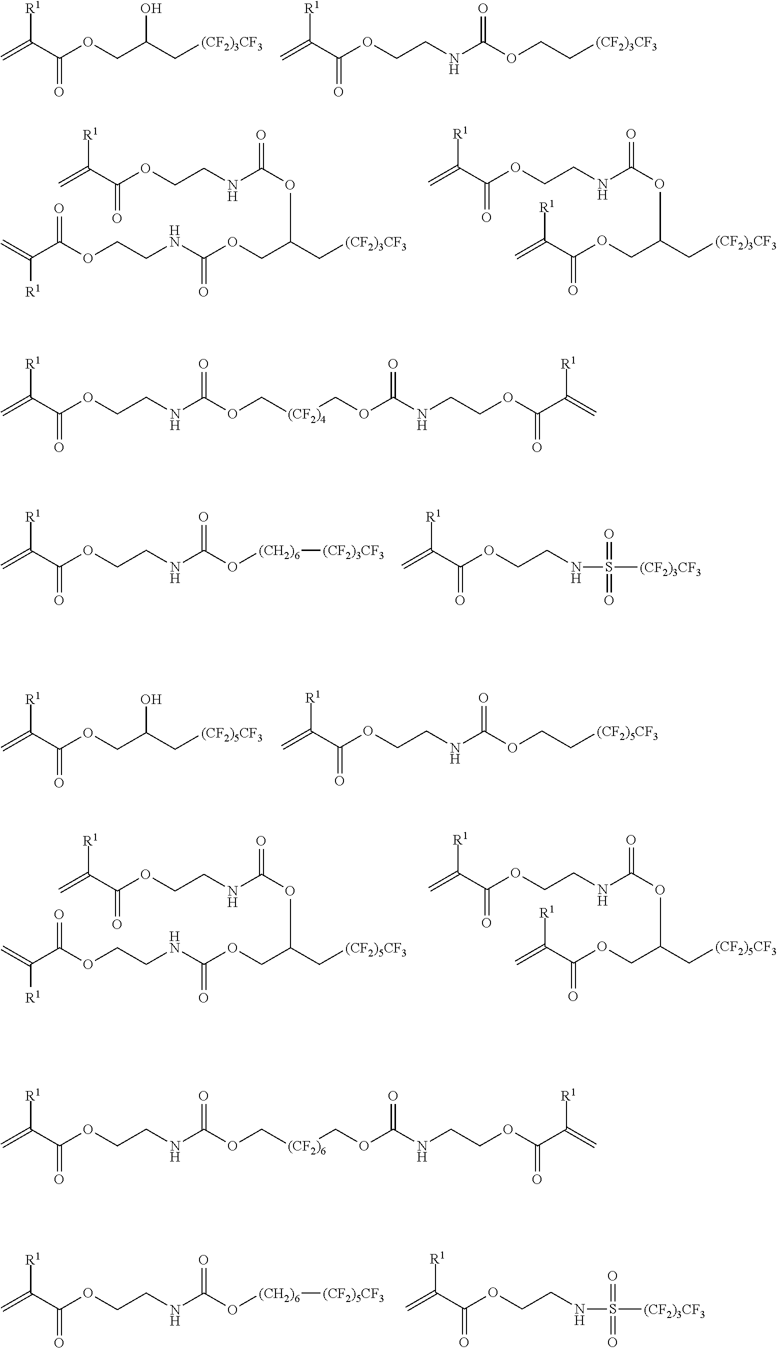

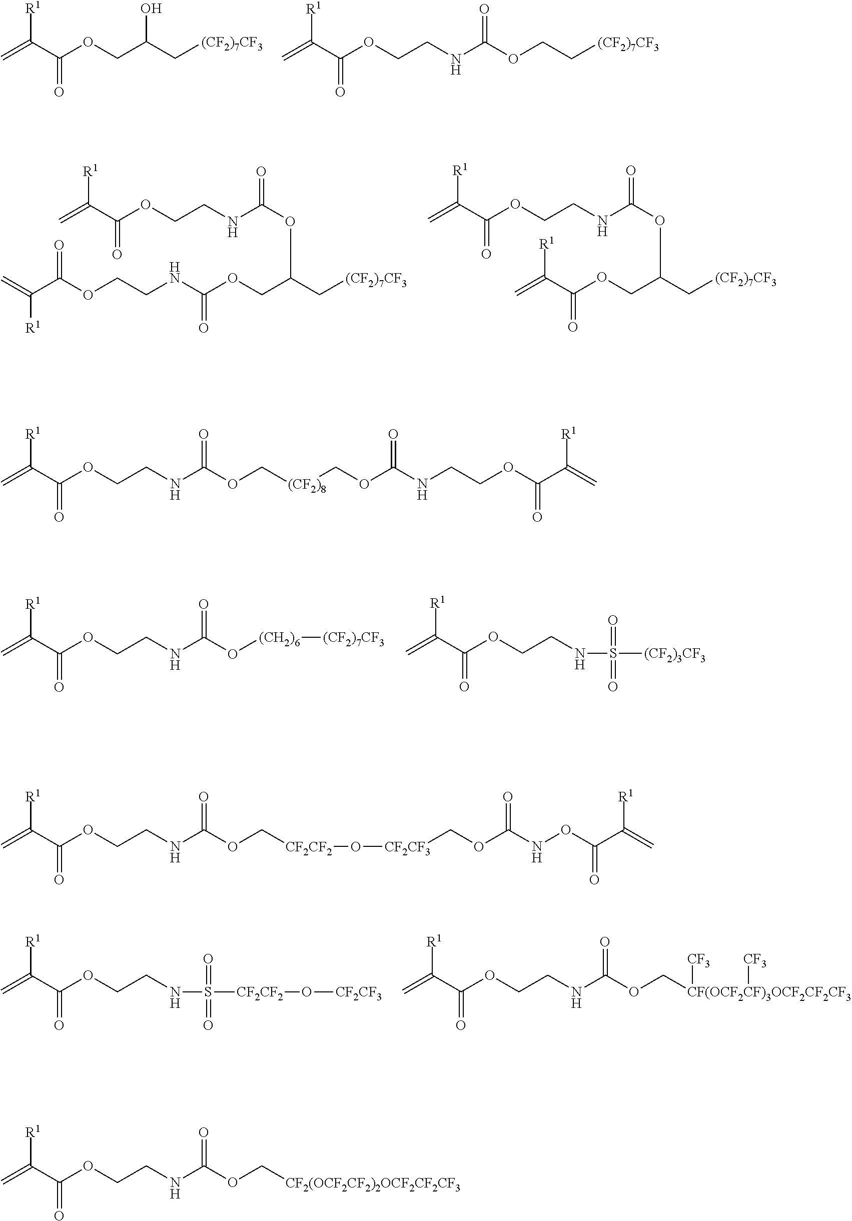

Content of the (Ax) in the curable composition of the present invention is not specifically limited. However, the amount relative to all of the polymerizable monomers is preferably 0.01 to 100% by mass, more preferably 0.05 to 50% by mass, furthermore preferably 0.1 to 20% by mass, particularly preferably 0.2 to 10% by mass, even particularly preferably 0.2 to 6% by mass.

### Other Polymerizable Monomer

In the curable composition of the present invention, it is preferred that, in addition to the polymerizable monomer (Ax), a polymerizable monomer other than the polymerizable monomer (Ax) is used from the viewpoint of the viscosity of the composition, the dry etching resistance, the imprint aptitude, and the curability.

Examples of the above other polymerizable monomer include a polymerizable unsaturated monomer having 1 to 6 of ethylenic unsaturated bond-having groups, a compound having an oxirane ring (an epoxy compound), a vinyl ether compound, a styrene derivative, a compound having a fluorine atom, propenyl ether, and butenyl ether. From the viewpoint of the curability of the composition, more preferred is a polymerizable unsaturated monomer having 1 to 6 of ethylenic unsaturated bond-having groups.

The polymerizable unsaturated monomer having from 1 to 6 of ethylenic unsaturated bond-having groups (from mono- to hexa-functional polymerizable unsaturated monomer) is described below.

The polymerizable unsaturated monomer having one ethylenic unsaturated bond-having group includes concretely 2-acryloyloxyethyl phthalate, 2-acryloyloxy-2-hydroxyethyl phthalate, 2-acryloyloxyethyl hexahydrophthalate, 2-acryloyloxypropyl phthalate, 2-ethyl-2-butylpropanediol acrylate, 2-ethylhexyl(meth)acrylate, 2-ethylhexylcarbitol(meth)acrylate, 2-hydroxybutyl(meth)acrylate, 2-hydroxyethyl(meth)acrylate, 2-hydroxypropyl(meth)acrylate, 2-hydroxyethyl(meth)acrylate, 3-methoxybuthyl(meth)acrylate, 4-hydroxybutyl(meth)acrylate, acrylic acid dimer, benzyl(meth)acrylate, 1- or 2-naphthyl(meth)acrylate, butanediol mono(meth)acrylate, butoxyethyl(meth)acrylate, buthyl(meth)acrylate, cetyl(meth)acrylate, ethyleneoxide-modified (hereinafter this may be referred to as “EO”) Cresol (meth)acrylate, dipropylene glycol(meth)acrylate, ethoxylated phenyl(meth)acrylate, ethyl(meth)acrylate, isoamyl(meth)acrylate, isobutyl(meth)acrylate, isooctyl(meth)acrylate, cyclohexyl(meth)acrylate, isobornyl(meth)acrylate, dicyclopentanyl(meth)acrylate, dicyclopentanyloxyethyl(meth)acrylate, isomyristyl(meth)acrylate, lauryl(meth)acrylate, methoxydiproylene glycol (meth)acrylate, methoxytripropylene glycol (meth)acrylate, methoxypolyethylene glycol(meth)acrylate, methoxytriethylene glycol (meth)acrylate, methyl(meth)acrylate, neopentyl glycol benzoate(meth)acrylate, nonylphenoxypolyethylene glycol(meth)acrylate, nonylphenoxypolypropylene glycol(meth)acrylate, octyl(meth)acrylate, paracumylphenoxyethylene glycol (meth)acrylate, epichlorohydrin (hereinafter referred to as “ECH”)-modified phenoxyacrylate, phenoxyethyl(meth)acrylate, phenoxydiethylene glycol (meth)acrylate, phenoxyhexaethylene glycol (meth)acrylate, phenoxytetraethylene glycol (meth)acrylate, polyethylene glycol(meth)acrylate, polyethylene glycol-polypropylene glycol(meth)acrylate, polypropylene glycol (meth)acrylate, stearyl(meth)acrylate, EO-modified succinic acid (meth)acrylate, tribromophenyl(meth)acrylate, EO-modified tribromophenyl(meth)acrylate, tridodecyl(meth)acrylate, p-isopropenylphenol, styrene, apha-styrene, and acrylonitrile.

Of those, preferred for use in the present invention are a mono-functional (meth)acrylate having an aromatic structure and/or alicyclic hydrocarbon structure in view of improving dry etching resistance, more preferably a mono-functional (meth)acrylate having an aromatic structure. Specific examples thereof include benzyl(meth)acrylate, phenoxyethyl(meth)acrylate, 1- or 2-naphthylmethyl(meth)acrylate, dicyclopentanyl(meth)acrylate, dicyclopentanyloxyethyl(meth)acrylate, isobornyl(meth)acrylate, adamantyl (meth)acrylate. More preferred examples thereof include benzyl(meth)acrylate, 2-naphthyl(meth)acrylate and 1- or 2-naphtylmethyl(meth)acrylate.

As the other polymerizable monomer, also preferred is a poly-functional polymerizable unsaturated monomer having two ethylenic unsaturated bond-containing groups.

Preferred examples of the di-functional polymerizable unsaturated monomer having two ethylenic unsaturated bond-containing groups for use in the present invention include diethylene glycol monoethyl ether (meth)acrylate, dimethylol-dicyclopentane di(meth)acrylate, di(meth)acrylated isocyanurate, 1,3-butylene glycol di(meth)acrylate, 1,4-butanediol di(meth)acrylate, EO-modified 1,6-hexanediol di(meth)acrylate, ECH-modified 1,6-hexanediol di(meth)acrylate, allyloxy-polyethylene glycol acrylate, 1,9-nonanediol di(meth)acrylate, EO-modified bisphenol A di(meth)acrylate, PO-modified bisphenol A di(meth)acrylate, modified bisphenol A di(meth)acrylate, EO-modified bisphenol F di(meth)acrylate, ECH-modified hexahydrophthalic acid diacrylate, hydroxypivalic acid neopentyl glycol di(meth)acrylate, neopentyl glycol di(meth)acrylate, EO-modified neopentyl glycol diacrylate, propyleneoxide (hereinafter referred to as “PO”)-modified neopentyl glycol diacrylate, caprolactone-modified hydroxypivalate neopentyl glycol, stearic acid-modified pentaerythritol di(meth)acrylate, ECH-modified phthalic acid di(meth)acrylate, poly(ethylene glycol-tetramethylene glycol) di(meth)acrylate, poly(propylene glycol-tetramethylene glycol) di(meth)acrylate, polyester(di)acrylate, polyethylene glycol di(meth)acrylate, polypropylene glycol di(meth)acrylate, ECH-modified propylene glycol di(meth)acrylate, silicone di(meth)acrylate, triethylene glycol di(meth)acrylate, tetraethylene glycol di(meth)acrylate, dimethyloltricyclodecane di(meth)acrylate, neopentyl glycol-modified trimethylolpropane di(meth)acrylate, tripropylene glycol di(meth)acrylate, EO-modified tripropylene glycol di(meth)acrylate, triglycerol di(meth)acrylate, dipropylene glycol di(meth)acrylate, divinylethylene-urea, divinylpropylene-urea.

Of those, especially preferred for use in the present invention are neopentyl glycol di(meth)acrylate, 1,9-nonanediol di(meth)acrylate, tripropylene glycol di(meth)acrylate, tetraethylene glycol di(meth)acrylate, hydroxypivalate neopentyl glycol di(meth)acrylate, polyethylene glycol di(meth)acrylate, o-, m-, or p-, benzene di(meth)acrylate, o-, m-, or p-xylylene di(meth)aclyate, etc.

Examples of the poly-functional polymerizable unsaturated monomer having at least three ethylenic unsaturated bond-having groups include ECH-modified glycerol tri(meth)acrylate, EO-modified glycerol tri(meth)acrylate, PO-modified glycerol tri(meth)acrylate, pentaerythritol triacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, caprolactone-modified dipentaerythritol hexa(meth)acrylate, dipentaerythritol hydroxy-penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy-tetra(meth)acrylate, pentaerythritol tetra(meth)acrylate, etc.

Of those, especially preferred for use in the present invention are EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, pentaerythritol ethoxy-tetra(meth)acrylate, pentaerythritol tetra(meth)acrylate, etc.

Of the above-mentioned (meth)acrylates, acrylates are preferable from the viewpoint of the curability.

The oxirane ring-having compound (epoxy compound) includes, for example, polyglycidyl esters of polybasic acids, polyglycidyl ethers of polyalcohols, polyglycidyl ethers of polyoxyalkylene glycols, polyglycidyl ethers of aromatic polyols, hydrogenated polyglycidyl ethers of aromatic polyols, urethane-polyepoxy compounds, epoxidated polybutadienes, etc. One or more of these compounds may be used either singly or as combined.

Examples of the oxirane ring-having compound (epoxy compound) preferred for use in the invention include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ether; polyglycidyl ethers of polyether polyols produced by adding one or more alkylene oxides to aliphatic polyalcohol such as ethylene glycol, propylene glycol, glycerin or the like; diglycidyl esters of aliphatic long-chain dibasic acids; monoglycidyl ethers of aliphatic higher alcohols; monoglycidyl ethers of polyether alcohols produced by adding alkyleneoxide to phenol, cresol, butylphenol or the like; glycidyl esters of higher fatty acids, etc.

Of those, especially preferred are bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, glycerin triglycidyl ether, trimethylolpropane triglycidyl ether, neopentyl glycol diglycidyl ether, polyethylene glycol diglycidyl ether, polypropylene glycol diglycidyl ether.

Commercial products favorable for use herein as the glycidyl group-having compound are UVR-6216 (by Union Carbide), Glycidol, AOEX24, Cyclomer A200 (all by Daicel Chemical Industry), Epikote 828, Epikote 812, Epikote 1031, Epikote 872, Epikote CT508 (all by Yuka Shell), KRM-2400, KRM-2410, KRM-2408, KRM-2490, KRM-2720, KRM-2750 (all by Asahi DenkaKogyo), etc. One or more of these may be used either singly or as combined.

The production method for the oxirane ring-having compounds is not specifically defined. For example, the compounds may be produced with reference to publications of Lecture of Experimental Chemistry 20, 4th Ed., Organic Synthesis II, p. 213, ff. (Maruzen, 1992); The chemistry of heterocyclic compounds-Small Ring Heterocycles, Part 3, Oxiranes (edited by Alfred Hasfner, John & Wiley and Sons, An Interscience Publication, New York, 1985); Yoshimura, Adhesive, Vol. 29, No. 12, 32, 1985; Yoshimura, Adhesive, Vol. 30, No. 5, 42, 1986; Yoshimura, Adhesive, Vol. 30, No. 7, 42, 1986; JP-A-11-100378, Japanese Patents 2906245 and 2926262.

As the other polymerizable monomer for use in the present invention, vinyl ether compounds may be used in the curable composition.

As the other polymerizable monomer for use in the invention, vinyl ether compounds may be in the composition. Any known vinyl ether compounds are usable, including, for example, 2-ethylhexyl vinyl ether, butanediol 1,4-divinyl ether, diethylene glycol monovinyl ether, ethylene glycol divinyl ether, triethylene glycol divinyl ether, 1,2-propanediol divinyl ether, 1,3-propanediol divinyl ether, 1,3-butanediol divinyl ether, 1,4-butanediol divinyl ether, tetramethylene glycol divinyl ether, neopentyl glycol divinyl ether, trimethylolpropane trivinyl ether, trimethylolethane trivinyl ether, hexanediol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethylene vinyl ether, triethylene glycol diethylene vinyl ether, ethylene glycol dipropylene vinyl ether, triethylene glycol diethylene vinyl ether, trimethylolpropane triethylene vinyl ether, trimethylolpropane diethylene vinyl ether, pentaerythritol diethylene vinyl ether, pentaerythritol triethylene vinyl ether, pentaerythritol tetraethylene vinyl ether, 1,1,1-tris[4-(2-vinyloxyethoxy)phenyl]ethane, bisphenol A divinyloxyethyl ether, etc.

These vinyl ether compounds can be produced, for example, according to the method described in Stephen. C. Lapin, Polymers Paint Colour Journal, 179 (4237), 321 (1989), concretely through reaction of a polyalcohol or a polyphenol with acetylene, or through reaction of a polyalcohol or a polyphenol with a halogenoalkyl vinyl ether. One or more of these compounds may be used either singly or as combined.

As the other polymerizable monomer for use in the invention, styrene derivatives may also be employed. The styrene derivatives include, for example, styrene, p-methylstyrene, p-methoxystyrene, β-methylstyrene, p-methyl-β-methylstyrene, α-methylstyrene, p-methoxy-β-methylstyrene, p-hydroxystyrene, etc.

The polymerizable monomer having fluorine atom other than the polymerizable monomer (A) including trifluoromethyl(meth)acrylate, pentafluoroethyl(meth)acrylate, perfluorobutyl-hydroxypropyl(meth)acrylate, (perfluorohexyl)ethyl(meth)acrylate, octafluoropentyl(meth)acrylate, and fluorooctylethyl(meth)acrylate, tetrafluoropropyl(meth)acrylate, 2,2,3,3,4,5,5-octafluoro hexandiol di(meth)acrylate.

As the other polymerizable monomer for use in the present invention, propenyl ethers and butenyl ethers may also be employed. Preferred examples of the propenyl ethers or butenyl ethers include 1-dodecyl-1-propenyl ether, 1-dodecyl-1-butenyl ether, 1-butenoxymethyl-2-norbornene, 1,4-di(1-butenoxy)butane, 1,10-di(1-butenoxy)decane, 1,4-di(1-butenoxymethyl)cyclohexane, diethylene glycol di(1-butenyl)ether, 1,2,3-tri(1-butenoxy)propane, and propenyl ether propylene carbonate.

Also Si atom-containing (meth)acrylate compounds are preferable as the another polymerizable monomer. Preferable examples of silicon-containing (meth)acrylate compounds include 3-(meth)acryloxypropyl tris(trimethylsiloxy)silane, (meth)acryloxymethylbis(trimethylsiloxy)methylsilane, (meth) acryloxymethyl tris(trimethylsiloxy)silane, 3-acryloxypropyl bis(trimethylsiloxy)methylsilane, and 1,3-bis(3-(meth)acryloxypropyl)tetramethyldisiloxane.

The another polymerizable monomer preferably contains 30 to 100% by mass of (meth)acrylate which has at least one of an aromatic group, alicyclic hydrocarbon group and Si atom, the content of which is preferably 70 to 100% by mass, and more preferably 90 to 100% by mass.

In a still more preferable embodiment, the another polymerizable monomer contains 50 to 100% by mass of (meth)acrylate polymerizable monomer which has an aromatic group (preferably a phenyl group or naphthyl group, and more preferably naphthyl group), the content of which is more preferably 70 to 100% by mass, and still more preferably 90 to 100% by mass.

The polymerizable monomer having an aromatic group used in the present invention is preferably a monofunctional (meth)acrylate compound represented by the following formula (I), or a polyfunctional (meth)acrylate compound represented by the following formula (II).

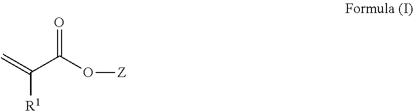

wherein Z is a group having an aromatic group, R¹ represents a hydrogen atom, an alkyl group, or a halogen atom; and, when the polymerizable monomer (Ax) is liquid at 25° C., the polymerizable monomer (Ax) has a viscosity of 500 mPa·s or less.

R¹ is preferably a hydrogen atom, or an alkyl group, more preferably a hydrogen atom, or a methyl group, further more preferably a hydrogen atom from the viewpoint of the curability of the composition. Examples of the halogen atom include fluorine atom, chlorine atom, bromine atom, and iodine atom, and preferred is fluorine atom.

Z is an aralkyl group which may have a substituent, an aryl group which may have a substituent, or a group in which those groups are bonded to each other via a linking group. The linking group may include a hetero atom. The linking group is preferably —CH₂—, —O —, —C(═O)—, —S—, or a combination thereof. The aromatic group contained in Z is preferably a phenyl group and a naphthyl group. The molecular weight of Z is preferably 90 to 300, more preferably 120 to 250.

When the polymerizable monomer represented by the formula (I) is liquid at 25° C., the viscosity thereof is preferably 2 to 500 mPa·s at 25° C., more preferably 3 to 200 mPa·s, further more preferably 3 to 100 mPa·s. The polymerizable monmer (Ax) is preferably liquid at 25° C., or solid having a melting point of 60° C. or less, more preferably solid having a melting point of 40° C. or less, further more preferably liquid at 25° C.

Z preferably represents —Z¹—Z². Z¹ is a single bond, or a hydrocarbon group which may have a linking group containing a hetero atom in the chain thereof. Z² is an aromatic group which may have a substituent. Z² has a molecular weight of 90 or more.

Z¹ is preferably a single bond, or an alkylene group which may have a linking group containing a hetero atom in the chain of the linking group. Z¹ is more preferably an alkylene group not having a linking group containing a hetero atom in the chain thereof, more preferably a methylene group, or an ethylene group. Examples of the linking group containing a hetero atom include —O—, —C(═O)—, —S—, and a combination of an alkylene group and at least one of —O—, —C(═O)— and —S—. The number of the carbon atoms of Z¹ is preferably 1 to 3.

Z² is also preferably a group in which two or more aromatic groups directly bond to each other, or a group in which two or more aromatic groups bond to each other via a linking group. The linking group is preferably —CH₂—, —O—, —C(═O)—, —S—, or a combination thereof.

Examples of a substituent which the aromatic group in the polymerizable monomer represented by the formula (I) may have include a halogen atom (fluorine atom, chlorine atom, bromo atom, iodine atom), a linear, a branched, or a cyclic alkyl group, an alkenyl group, an alkynyl group, an aryl group, an acyl group, an alkoxycarbonyl group, an aryloxycarbonyl group, a carbamoyl group, a cyano group, a carboxyl group, a hydroxy group, an alkoxy group, an aryloxy group, an alkylthio group, an arylthio group, a heterocyclic-oxy group, an acyloxy group, an amino group, a nitro group, a hydrazino group, a heterocyclic group. A group which is substituted with those groups is also preferred.

The amount of the compound represented by the formula (I) to be added in the photo-curable composition is preferably 10 to 100% by mass, more preferably 20 to 100% by mass, further more preferably 30 to 80% by mass.

Specific examples of the compounds represented by the formula (I), but have no substituent on the aromatic ring, preferably include benzyl(meth)acrylate, phenethyl (meth)acrylate, fenoxyethyl(meth)acrylate, 1- or 2-naphthyl (meth)acrylate, 1- or 2-naphthylmethyl(meth)acrylate, 1- or 2-naphthylethyl(meth)acrylate, and 1- or 2-naphthoxyethyl(meth)acrylate.

As the compound represented by the formula (I), also a compound which has substituents on the aromatic ring, represented by the formula (II) below, is preferable.

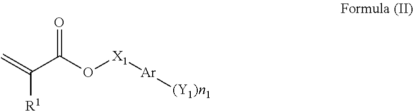

wherein R¹ represents a hydrogen atom, an alkyl group, or a halogen atom; X¹ is a single bond, or a hydrocarbon group which may have a linking group containing a hetero atom in the chain of the linking group; Y¹ represents a substituent having a molecular weight of 15 or more; n1 represents an integer of 1 to 3; and Ar is a linking group having aromatic group, preferably a phenylene group and a naphthylene group.

R¹ is the same as R¹ in the above formula (I) and the preferable range thereof is the same as R¹ in the above formula (I).

X¹ is the same as Z¹ in the above and the preferable range thereof is the same as Z¹ in the above.

Y¹ is a substituent having a molecular weight of 15 or more. Examples of Y¹ include an alkyl group, an alkoxy group, an aryloxy group, an alkenyl group, an aralkyl group, an acyl group, an alkoxycarbonyl group, an alkylthio group, an arylthio group, a halogen atom and a cyano group. Those substituents may have a substituent.

When n1 is 2, X¹ is preferably a hydrocarbon group having 1 carbon atom.

In particular, the more preferred embodiment is that n1 is 1 and X¹ is an alkylene group having 1 to 3 carbon atoms.

The compound represented by the formula (II) is preferably compounds represented by the formula (IV) or (V).

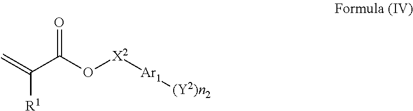

wherein R¹ represents a hydrogen atom, an alkyl group, or a halogen atom; X² is a single bond, or a hydrocarbon group which may have a linking group containing a hetero atom in the chain of the linking group; Y² represents a substituent having a molecular weight of or more, the substituent being other than an aromatic group-containing group; n2 represents an integer of 1 to 3.

R¹ is the same as R¹ in the above formula (I) and the preferable range thereof is the same as R¹ in the above formula (I).

When X² is a hydrocarbon group, X² is preferably a hydrocarbon group having 1 to 3 carbon atoms, more preferably a substituted or unsubstituted alkylene group having 1 to 3 carbon atoms, further more preferably an unsubstituted alkylene group having 1 to 3 carbon atoms, still more preferably an ethylene group. By applying such a hydrocarbon group, it makes possible to provide a composition having lower viscosity and lower volatility.

Y² represents a substituent which has a molecular weight of 15 or more and the substituent is not an aromatic group-containing group. The upper limit of the molecular weight of Y² is preferably 150 or less. Examples of Y² include an alkyl group having 1 to 6 carbon atoms such as methyl group, ethyl group, isopropyl group, tert-butyl group, and cyclohexyl group, a halogen atom such as chlorine atom and bromo atom, and an alkoxy group having 1 to 6 carbon atoms such as methoxy group, ethoxy group, and cyclohexyloxy group.

n2 is preferably an integer of 0 to 2. When n2 is 1, the substituent Y² is preferably at para-position in the compound. When n2 is 2, X² is preferably a single bond, or a hydrocarbon group having one carbon atom from the viewpoint of the viscosity of the composition.

The molecular weight of the (meth)acrylate represented by the formula (IV) is preferably 175 to 250, more preferably 185 to 245 from the viewpoint of attainment of the low viscosity and the low volatility.

The viscosity at 25° C. of the (meth)acrylate represented by the formula (IV) is preferably 50 mPa·s or less, more preferably 20 mPa·s or less.

In addition, the compound represented by the formula (IV) preferably is used for a reaction diluent.

The amount of the compound represented by the formula (IV) to be added is preferably 10% by mass or more, more preferably 15% by mass or more, further more preferably 20% by mass or more from the viewpoint of the viscosity of the composition and the pattern accuracy of the cured film. While the amount thereof to be added is preferably 95% by mass or less, more preferably 90% by mass or less, further more preferably 85% by mass or less from the viewpoint of the tackiness of the cured film and the mechanical strength of the cured film.

Specific examples of the compounds represented by Formula (IV) are shown below, to which, however, the present invention should not be limited. In the following compounds, R₁ is hydrogen atom, or methyl group.

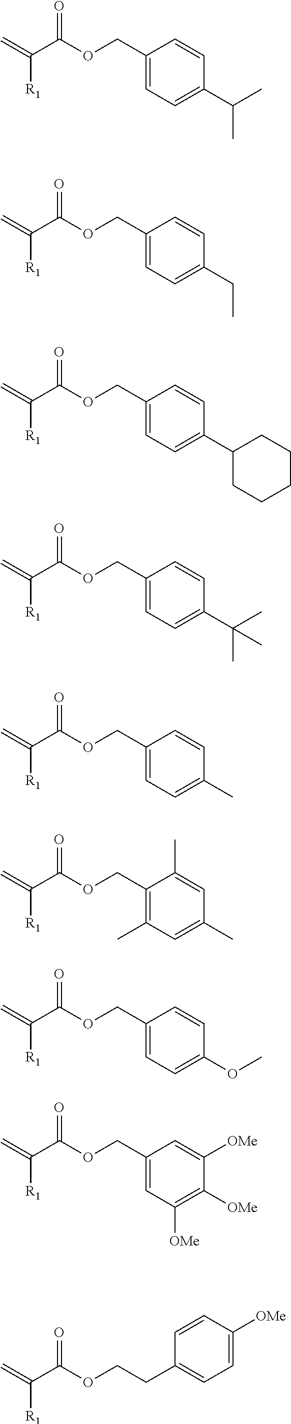

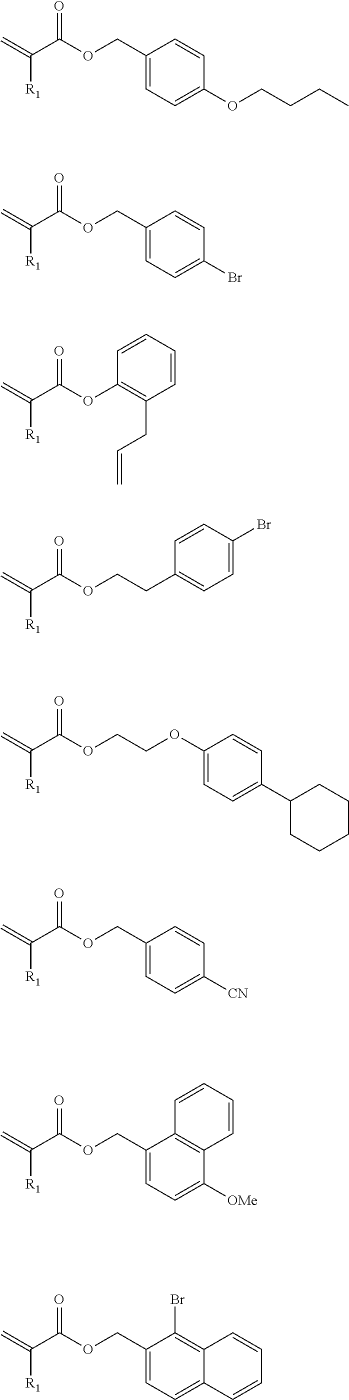

The compound represented by the formula (V):

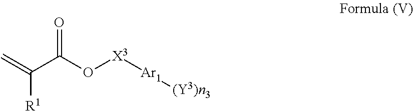

wherein R¹ represents a hydrogen atom, an alkyl group, or a halogen atom; X³ is a single bond, or a hydrocarbon group which may have a linking group containing a hetero atom in the chain of the linking group; Y³ represents a substituent having an aromatic group; and n3 represents an integer of 1 to 3.

R¹ is the same as R¹ in the above formula (I) and the preferable range thereof is the same as R¹ in the above formula (I).

X³ is the same as X² in the above formula (IV) and the preferable range thereof is the same as X² in the above formula (IV).

Y³ represents a substituent having an aromatic group. Preferred embodiment of the substituent having an aromatic group is the embodiment that an aromatic group bonds to the aromatic ring in the formula (V) directly, or via a linking group. Preferred example of the linking group thereof include an alkylene group, a linking group containing a hetero atom (preferably —O—, —S—, —C(═O)O—) and a combination thereof. Among them, an alkylene group, —O— and a combination thereof is more preferable. The substituent having an aromatic group and having a molecular weight of 15 or more is preferably a substituent having a phenyl group. Embodiment in which a phenyl group bonds to the aromatic ring in the formula (V) directly, or via the above mentioned linking group is preferable. The substituent having an aromatic group is preferably a phenyl group, a benzyl group, a phenoxy group, a benzyloxy group and a phenylthio group. The molecular weight of Y³ is preferably 230 to 350.

n3 is preferably 1 or 2, more preferably 1.

The amount of the compound represented by the formula (V) to be added in the composition of the present invention is preferably 10% by mass or more, more preferably 20% by mass or more, further more preferably 30% by mass or more. On the other hand, the amount thereof is preferably 90% by mass or less, more preferably 80% by mass or less, further more preferably 70% by mass, from the viewpoint of the tackiness and mechanical strength of the cured film.

Specific examples of the compounds represented by Formula (V) are shown below, to which, however, the present invention should not be limited. In the following compounds, R₁ is hydrogen atom or methyl group.

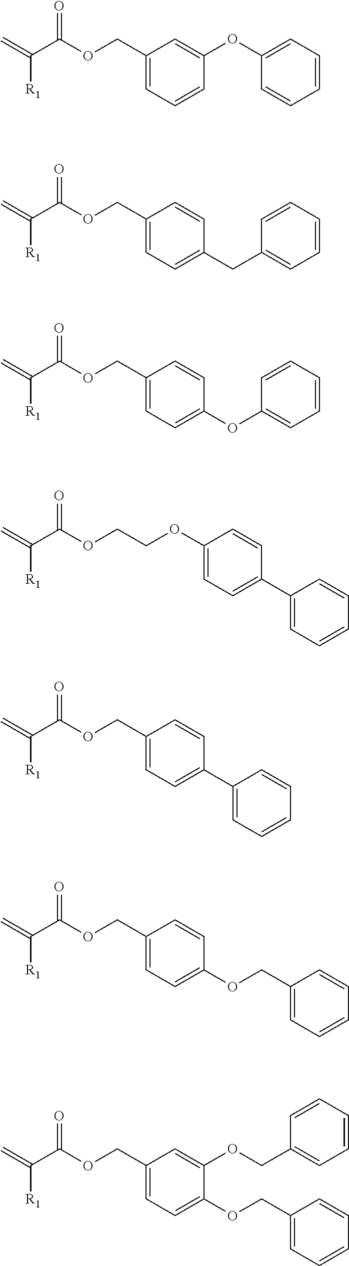

The polyfunctional (meth)acrylate represented by the formula (II):

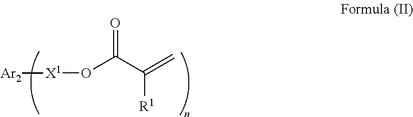

wherein Ar₂ is a n-valent linking group having an aromatic group, preferably a linking group having a phenylene group. X₂ and R¹ are the same as those in Formula (II). n is an integer of 1 to 3, preferably 1.

The compound represented by the formula (II) is preferably compounds represented by the formula (VI) or (VII).

The compound represented by the formula (VI):

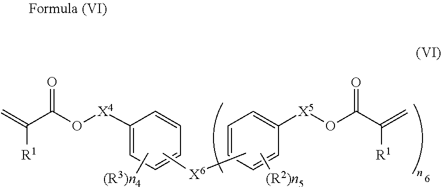

wherein X⁶ is a single bond or a (n6+1)-valent linking group; R¹ each are a hydrogen atom, an alkyl group, or a halogen atom; R² and R³ each are a substituent; n4 and n5 each are an integer of 0 to 4; n6 is 1 or 2; and X⁴ and X⁵ each are a hydrocarbon group which may have a linking group containing a hetero atom in the chain of the linking group.

X⁶ is a single bond or a (n6+1)-valent linking group, preferably a single bond, an alkylene group, —O—, —S—, —C(═O)O—, or a linking group consisting of a combination of two or more thereof. The alkylene group is preferably an alkylene group having 1 to 8 carbon atoms, more preferably an alkylene group having 1 to 3 carbon atoms. Also, the alkylene group is preferable an unsubstituted alkylene group.

n6 is preferably 1. When n6 is 2, the plural R¹, X⁵ and R² existing in the formula may be the same or different.

X⁴ and X⁵ each are an alkylene group not having a linking group, more preferably an alkylene group having 1 to 5 carbon atoms, further more preferably an alkylene group having 1 to 3 carbon atoms, still more preferably a methylene group.

R¹ is the same as R¹ in the above formula (I) and the preferable range thereof is the same as R¹ in the above formula (I).

R² and R³ each represent a substituent, preferably an alkyl group, a halogen atom, an alkoxy group, an acyl group, an acyloxy group, an alkoxycarbonyl group, a cyano group, a nitro group. The alkyl group is preferably an alkyl group having 1 to 8 carbon atoms. The halogen atom is exemplified by fluorine atom, chlorine atom, bromine atom and iodine atom, and is preferably fluorine atom. The alkoxy group is preferably an alkoxy group having 1 to 8 carbon atoms. The acyl group is preferably an acyl group having 1 to 8 carbon atoms. The acyloxy group is preferably an acyloxy group having 1 to 8 carbon atoms. The alkoxycarbonyl group is preferably an alkoxycarbonyl group having 1 to 8 carbon atoms.

n4 and n5 each are an integer of 0 to 4. When n4 or n5 is two or more, the plural R² and R³ existing in the formula may be the same or different.

The compound represented by the formula (VI) is preferably a compound represented by the formula (VII):

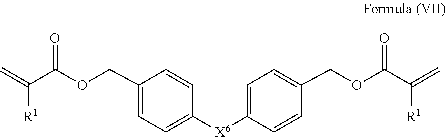

wherein X⁶ represents an alkylene group, —O—, —S—, or a linking group which is combined with two or more thereof; R¹ each are a hydrogen atom, an alkyl group, or a halogen atom.

R¹ is the same as R¹ in the above formula (I) and the preferable range thereof is the same as R¹ in the above formula (I).

When X⁶ is an alkylene group, the alkylene group is preferably an alkylene group having 1 to 8 carbon atoms, more preferably an alkylene group having 1 to 3 carbon atoms. The alkylene group is preferably an unsubstituted alkylene group.

X⁶ is preferably —CH₂—, —CH₂CH₂—, —O—, or —S—.

The amount of the compound represented by the formula (VI) to be contained in the composition of the present invention is not defined. However, the content relative to the total amount of the polymerizable monomers is preferably 1 to 100% by mass, more preferably 5 to 70% by mass, further more preferably 10 to 50% by mass from the viewpoint of the curability and the viscosity of the composition.

Specific examples of the compounds represented by Formula (VI) are shown below, to which, however, the present invention should not be limited, wherein R¹ in the following is the same as R¹ in the above formula (VI), the preferable range thereof is the same as R¹ in the above formula (VI). The R¹ is more preferably a hydrogen atom.

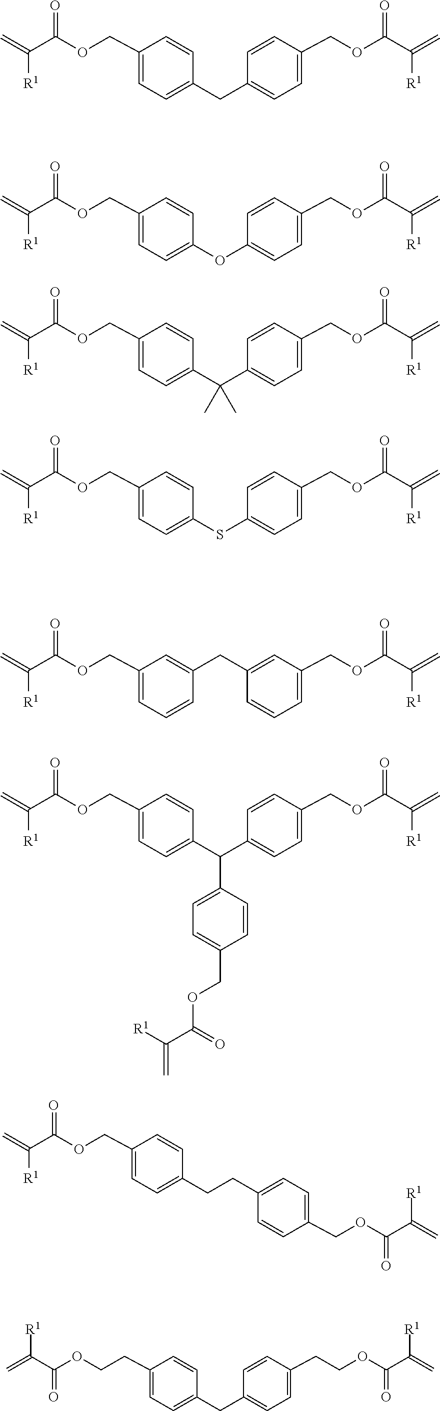

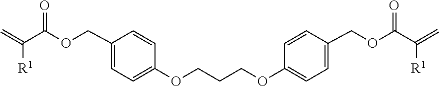

The compound represented by the following formula (VIII):

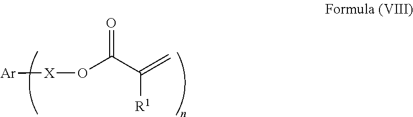

wherein Ar is an arylene group which may have a substituent, X is a single bond or an organic linking group, R¹ is hydrogen atom or methyl group, and n is 2 or 3.

In the formula, the above arylene group is exemplified by a hydrocarbon arylene group such as phenylene group and naphthylene group and a heteroarylene group which is a crosslinking group derived from indole or carbazole, and is preferably phenylene group from the viewpoints of the viscosity and the etching resistance. The above arylene group may have a substituent, and examples of the preferable substituent thereof include an alkyl group, an alkoxy group, hydroxy group, an alkoxycarbonyl group, an amide group, and a sulfone amide group.

The organic linking group in the above X is exemplified by an alkylene group, an arylene group and an aralkylene group which may include a hetero atom in the chain. Of those, preferred are an alkylene group and an arylene group, more preferred is an alkylene group. The above X is particularly preferably a single bond or an alkylene.

The above R¹ is hydrogen atom or methyl group, preferably hydrogen atom.

n is 2 or 3, preferably 2.

The above polymerizable monomer represented by the formula (VIII) is preferably the following formula (I-a) or the following formula (I-b) from the viewpoint of reduction of the viscosity of the composition.

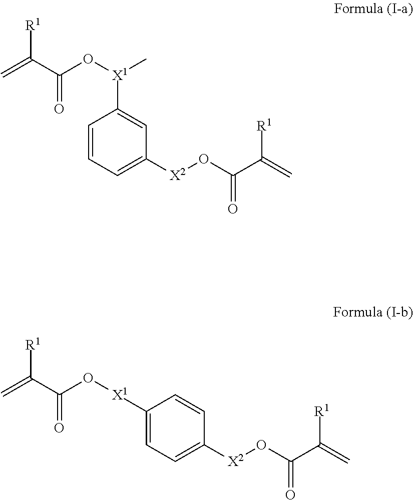

wherein X¹ and X² each independently are a single bond or an alkylene group which may have a substituent having 1 to 3 carbon atoms, R¹ is hydrogen atom or methyl group.

In the formula (I-a), the above X¹ is preferably a single bond or methylene group, more preferably methylene group from the viewpoint of reduction of the viscosity.

The preferred range of the above X² is the same as the above X¹.

The above R¹ is the same as R¹ in the above formula (VIII) and the preferred range is also the same.

The above polymerizable monomer is preferably liquid at 25° C. since liquid can control occurring foreign substance if the amount to be added thereof is increased.

Specific examples of the preferable polymerizable monomer are shown below. R¹ in the following monomer is the same as R¹ in the above formula, that is, R¹ is hydrogen atom or methyl group. The invention is not limited thereto.

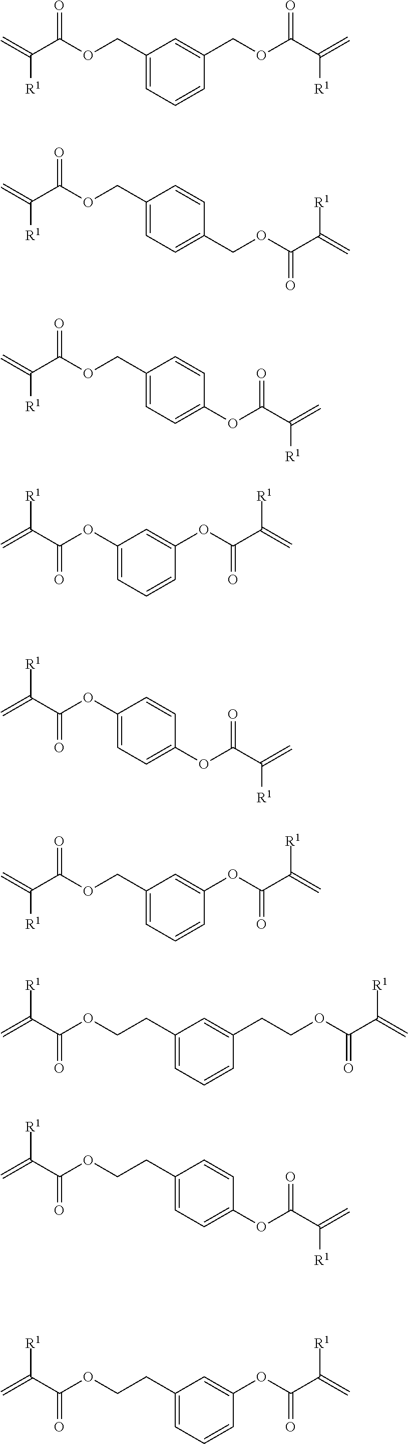

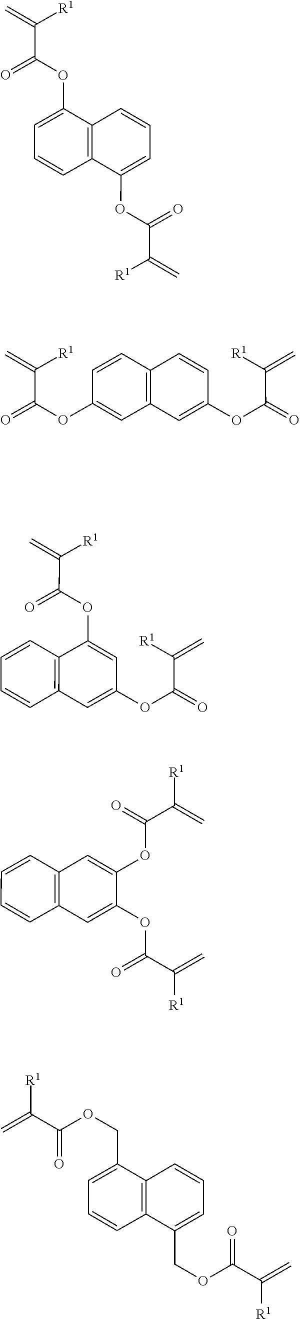

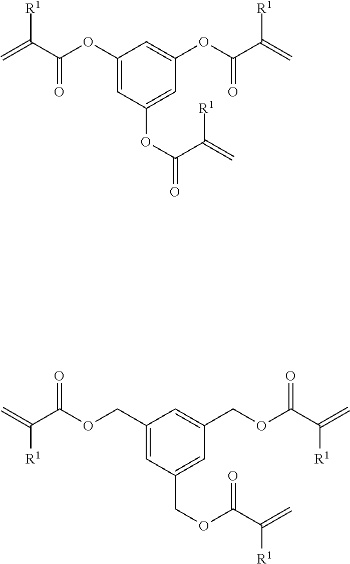

Still more preferable examples of the polymerizable monomer, which has an aromatic group, used in the photo-curable composition in the present invention will be enumerated below, without limiting the present invention.

Preferable examples of the polymerizable monomer which has an aromatic group include benzyl(meth)acrylate which is non-substituted or has substituent(s) on the aromatic ring thereof, phenethyl(meth)acrylate which is non-substituted or has substituent(s) on the aromatic ring thereof, fenoxyethyl (meth)acrylate which is non-substituted or has substituent (s) on the aromatic ring thereof, 1- or 2-naphthyl(meth)acrylate which is non-substituted or has substituent(s) on the aromatic ring thereof, 1- or 2-naphthylmethyl(meth)acrylate which is non-substituted or has substituent(s) on the aromatic ring thereof, 1- or 2-naphthylethyl(meth)acrylate which is non-substituted or has substituent(s) on the aromatic ring thereof, 1- or 2-naphthoxyethyl(meth)acrylate, resorcinol di(meth)acrylate, m-xylylene di(meth)acrylate, naphthalene di(meth)acrylate, and ethoxylated bisphenol A diacrylate, and more preferable examples include benzyl acrylate which is non-substituted or has substituent(s) on the aromatic ring thereof, 1- or 2-naphthylmethyl acrylate, and m-xylylene diacrylate.

In a particularly preferable embodiment, the another polymerizable monomer contains 0 to 80% by mass, preferably 20 to 70% by mass, of a polymerizable monomer which contains an aromatic group (preferably a phenyl group and naphthyl group, more preferably a naphthyl group) and one (meth)acrylate group, which is preferably the compound represented by the formula (I); and 20 to 100% by mass, preferably 30 to 80% by mass, of a polymerizable monomer which contains an aromatic group (preferably a phenyl group or naphthyl group, more preferably a phenyl group) and two (meth)acrylate groups, which is preferably the compound represented by the formula (II).

The amount of the above-mentioned other polymerizable monomer to be added depends on the amount of the polymerizable monomer (Ax) used in the present invention to be added. For example, it may be 0 to 90.9% by mass, preferably 50 to 99.8% by mass, further more preferably 90 to 99.5% by mass, relative to all the polymerizable compounds.

Next described is a preferable blend embodiment of the polymerizable monomer (Ax) in the present invention and the other polymerizable monomer.

A monofunctional polymerizable monomer is generally used as a reactive diluent, and has an effect of lowering the viscosity of the curable composition of the present invention, and it is preferably added in an amount of at least 15% by mass, more preferably from 20 to 90% by mass, even more preferably from 25 to 85% by mass, and particularly preferably from 30 to 80% by mass, relative to the total amount of the polymerizable monomers in the composition.

A monomer having two polymerizable-reactive groups (difunctional polymerizable monomer) is added in an amount of preferably 90% by mass or less, more preferably 80% by mass or less, and particularly preferably 70% by mass or less, relative to the total amount of all the polymerizable monomers.

The proportion of the monofunctional and difunctional polymerizable monomers to be added is preferably from 10 to 100% by mass, more preferably from 30 to 100% by mass, and particularly preferably from 50 to 90% by mass, relative to the total amount of the polymerizable monomers in the composition.

The proportion of the polyfunctional polymerizable monomer having three or more unsaturated bond-having groups is preferably at most 50% by mass, more preferably at most 30% by mass, and particularly preferably at most 10% by mass, relative to the total amount of all the polymerizable monomers. When the proportion of the polymerizable monomer having three or more polymerizable-reactive groups is at 80% by mass or less, the viscosity of the composition can be lowered, thereby it becoming preferable. The most preferable embodiment is that the composition includes only a monofunctional and/or difunctional polymerizable monomer and does not include a polyfunctional monomer.

### (Photo-Polymerization Initiator)

The curable composition of the present invention contains a photo-polymerization initiator. The photo-polymerization initiator used in the present invention may be anything so far as it can generate, upon irradiation of light, an active species which promotes polymerization of the polymerizable monomer (A). The photo-polymerization initiator may be exemplified by cationic polymerization initiator and radical polymerization initiator, wherein the radical polymerization initiator is preferable. In the present invention, a plurality of species of photo-polymerization initiator may be used in combination.

Content of the photo-polymerization initiator used for the present invention, relative to the total composition excluding solvent, is typically 0.01 to 15% by mass, preferably 0.1 to 12% by mass, and still more preferably 0.2 to 7% by mass. For the case where two or more species of photo-polymerization initiators are used, the total amount is adjusted to the above-described ranges.

A content of photo-polymerization initiator of 0.01% by mass or above is preferable since the sensitivity (quick curability), resolution, line edge roughness, and film strength tend to improve. On the other hand, a content of photo-polymerization initiator of 15% by mass or less is preferable since the transmissivity of light, coloration and handlability tend to improve.

Commercially available initiators may be adoptable to the radical photo-polymerization initiator in the present invention. Those described in paragraph [0091] in Japanese Laid-Open Patent Publication No. 2008-105414 may preferably be used. Among them, acetophenone-base compound, acylphosphine oxide-base compound, and oxime ester-base compound are preferable from the viewpoint of curing sensitivity and absorption characteristics.

The acetophenone-base compound may preferably be exemplified by hydroxyacetophenone-base compound, dialkoxyacetophenone-base compound, and aminoacetophenone-base compound. The hydroxyacetophenone-base compound may preferably be exemplified by Irgacure (registered trademark) 2959 (1-[4-(2-hydroxyethoxy)phenyl]-2-hydroxy-2-methyl-1-propane-1-one, Irgacure (registered trademark) 184 (1-hydroxycyclohexylphenylketone), Irgacure (registered trademark) 500 (1-hydroxycyclohexylphenylketone, benzophenone), Darocur (registered trademark) 1173 (2-hydroxy-2-methyl-1-phenyl-1-propane-1-one), all of which are available from BASF.

The dialkoxyacetophenone-base compound may preferably be exemplified by Irgacure (registered trademark) 651 (2,2-dimethoxy-1,2-diphenylethane-1-one) available from BASF.

The aminoacetophenone-base compound may preferably be exemplified by Irgacure (registered trademark) 369 (2-benzyl-2-dimethylamino-1-(4-morpholinophenyl)butanone-1), Irgacure (registered trademark) 379(EG) (2-dimethylamino-2-(4-methylbenzyl)-1-(4-morpholine-4-yl-phenyl)butane-1-one, and Irgacure (registered trademark) 907 (2-methyl-1-[4-methylthiophenyl]-2-morpholinopropane-1-one), all of which are available from BASF.

The acylphosphine oxide-base compound may preferably be exemplified by Irgacure (registered trademark) 819 (bis(2,4,6-trimethylbenzoyl)-phenylphosphine oxide), and Irgacure (registered trademark) 1800 (bis(2,6-dimethoxybenzoyl)-2,4,4-trimethyl-pentylphosphine oxide), all of which are available from BASF; and Lucirin TPO (2,4,6-trimethylbenzoyldiphenylphosphine oxide), and Lucirin TPO-L (2,4,6-trimethylbenzoylphenylethoxyphosphine oxide), all of which are available from BASF.

The oxime ester-base compound may preferably be exemplified by Irgacure (registered trademark) OXE01 (1,2-octanedione,1-[4-(phenylthio)phenyl]-2-(O-benzoyloxime)), and Irgacure (registered trademark) OXE02 (ethanone,1-[9-ethyl-6-(2-methylbenzoyl)-9H-carbazole-3-yl]-1-(O-acetyloxime)), all of which are available from BASF.

The cation photo-polymerization initiator adoptable to the present invention is preferably sulfonium salt compound, iodonium salt compound, and oxime sulfonate compound, and may preferably be exemplified by 4-methylphenyl[4-(1-methylethyl)phenyliodonium tetrakis(pentafluorophenyl)borate (PI2074, from Rhodia), 4-methylphenyl[4-(2-methylpropyl)phenyliodonium hexafluorophophate (Irgacure 250, from BASF, Irgacure PAG103, 108, 121 and 203 (from BASF).

In the present invention, “light” includes not only those having with a wavelength falling within a range of ultraviolet, near-ultraviolet, far-ultraviolet, visible, infrared, and electromagnetic waves but also radiations. The radiations include, for example, microwaves, electron beams, EUV, X-rays. In addition, laser rays such as 248 nm excimer laser, 193 nm excimer laser, 172 nm excimer laser are also usable herein. These lights may be monochromatic lights (single wavelength lights) having passed through optical filters, or may be lights of different wavelengths (composite lights). For photoexposure, multiple photoexposure may be employable, and for the purpose of enhancing the film strength and the etching resistance of the composition, entire surface photoexposure may be effected after pattern formation.

### (Other Ingredients)

In addition to the above-mentioned polymerizable monomers and the photopolymerization initiator, the curable composition of the present invention may comprise any other ingredients such as a surfactant, an antioxidant, a solvent, a polymer, a pigment, a dye and others for various purposes not deviating from the effect of the present invention. Preferably, the curable composition of the present invention comprises at least one selected from a surfactant and an antioxidant.

### —Surfactant—

The curable composition of the invention may contain a surfactant. The content of the surfactant that may be in the composition may be, for example, from 0.001 to 5% by mass of the composition, preferably from 0.002 to 4% by mass, more preferably from 0.005 to 3% by mass. In case where two or more different types of surfactants are in the composition, the total amount thereof falls within the above range. When the surfactant content in the composition falls from 0.001 to 5% by mass, it is favorable from the viewpoint of the coating uniformity, therefore hardly worsening the mold transferability owing to excessive surfactant.

Preferably, the composition comprises at least one of a fluorine-containing surfactant, a silicone-type surfactant and a fluorine-containing silicone-type surfactant as the surfactant. More preferably, the composition comprises both of a fluorine-containing surfactant, a silicone-type surfactant, or a fluorine-containing silicone-type surfactant as the surfactant. Further more preferably, the composition comprises a fluorine-containing silicone-type surfactant as the surfactant.

“Fluorine-containing silicone-type surfactant” as referred to herein means a surfactant satisfying both the requirement of a fluorine-containing surfactant and that of a silicone-type surfactant.

Using the surfactant of the type may solve the problem of coating failures such as striation and flaky pattern formation (drying unevenness of resist film) that may occur when the curable composition of the invention is applied onto substrates on which various films are formed, for example, onto silicon wafers in semiconductor production, or onto glass square substrates, chromium films, molybdenum films, molybdenum alloy films, tantalum films, tantalum alloy films, silicon nitride films, amorphous silicon films, tin oxide-doped indium oxide (ITO) films or tin oxide films in production of liquid-crystal devices. In addition, the surfactant is effective for enhancing the flowability of the curable composition of the invention in the cavity of a female mold, for enhancing the mold-resist releasability, for enhancing the resist adhesiveness to substrates, and for lowering the viscosity of the composition. In particular, when the above-mentioned surfactant is added to the curable composition of the invention, the coating uniformity of the composition can be greatly improved; and in coating with it using a spin coater or a slit scan coater, the composition ensures good coating aptitude irrespective of the size of the substrate to which it is applied.

Examples of the nonionic fluorine-containing surfactant usable in the invention include Fluorad FC-430, FC-431 (Sumitomo 3M's trade names); Surflon S-382 (Asahi Glass's trade name); Eftop EF-122A, 122B, 122C EF-121, EF-126, EF-127, MF-100 (Tochem Products' trade names); PF-636, PF-6320, PF-656, PF-6520 (Omnova Solution's trade names); Futagent FT250, FT251, DFX18 (Neos' trade names); Unidyne DS-401, DS-403, DS-451 (Daikin's trade names); Megafac 171, 172, 173, 178K, 178A, F780F (Dai-Nippon Ink's trade names).

Examples of the nonionic silicone-type surfactant include SI-10 series (Takemoto Yushi's trade name), Megafac Paintad 31 (Dai-Nippon Ink's trade name), KP-341 (Shin-Etsu Chemical's trade name).

Examples of the fluorine-containing silicone-type surfactant include X-70-090, X-70-091, X-70-092, X-70-093 (Shin-Etsu Chemical's trade names); Megafac R-08, XRB-4 (Dai-Nippon Ink's trade names).

### —Antioxidant—

Preferably, the curable composition of the invention comprises a known antioxidant. The content of the antioxidant to be in the composition is, for example, from 0.01 to 10% by mass, preferably from 0.2 to 5% by mass. When two or more different types of antioxidants are in the composition, the total amount thereof falls within the above range.

The antioxidant is for preventing fading by heat or photoirradiation, and for preventing fading by various gases such as ozone, active hydrogen NOx, SOx (x is an integer), etc. Especially in the invention, the antioxidant added to the composition brings about the advantage that the cured film is prevented from being discolored and the film thickness is prevented from being reduced through decomposition. The antioxidant includes hydrazides, hindered amine-type antioxidants, nitrogen-containing heterocyclic mercapto compounds, thioether-type antioxidants, hindered phenol-type antioxidants, ascorbic acids, zinc sulfate, thiocyanates, thiourea derivatives, saccharides, nitrites, sulfites, thiosulfates, hydroxylamine derivatives, etc. Of those, preferred are hindered phenol-type antioxidants and thioether-type antioxidants from the viewpoint of their effect of preventing cured film discoloration and preventing film thickness reduction.

Commercial products of the antioxidant usable herein include Irganox 1010, 1035, 1076, 1222 (all by Ciba-Geigy); Antigene P, 3C, FR, Sumilizer S, Sumilizer GA80 (by Sumitomo Chemical); Adekastab AO70, AO80, AO503 (by Adeka), etc. These may be used either singly or as combined.

### —Polymerization Inhibitor—

Furthermore, the curable composition for imprints of the invention preferably comprises a polymerization inhibitor. The content of the polymerization inhibitor is from 0.001 to 1% by mass, more preferably from 0.005 to 0.5% by mass, and even more preferably from 0.008 to 0.05% by mass, relative to all the polymerizable monomers, and the change in the viscosities over time can be inhibited while maintaining a high curing sensitivity by blending the polymerization inhibitor in an appropriate amount. The polymerization inhibitor may be added at the production of the polymerizable monomer or may be added the curable composition after the production of the polymerizable monomer.

The polymerization inhibitor may be exemplified by hydroquinone, p-methoxyphenol, di-tert-butyl-p-cresol, pyrogallol, tert-butylcatechol, benzoquinone, 4,4′-thiobis(3-methyl-6-tert-butylphenol), 2,2′-methylenebis(4-methyl-6-tert-butylphenol), cerium (III) salt of N-nitrosophenyl hydroxylamine, phenothiazine, phenoxazine, 4-methoxynaphthol, 2,2,6,6-tetramethylpiperidine-1-oxyl, free radical, 2,2,6,6-tetramethylpiperidine, 4-hydroxy-2,2,6,6-tetramethylpiperidine-1-oxyl, free radical, nitrobenzene, and dimethylaniline; among which preferable examples include p-benzoquinone, 2,2,6,6-tetramethylpiperidine-1-oxyl, free radical, 4-hydroxy-2,2,6,6-tetramethylpiperidine-1-oxyl, free radical.

### —Solvent—

A solvent may be used for the curable composition for imprints of the invention, in accordance with various needs. Preferably, the solvent has a boiling point at a pressure of 1 atmosphere of from 80 to 200° C. Regarding the type of the solvent, any solvent capable of dissolving the composition may be used. Preferred are solvents having at least any one of an ester structure, a ketone structure, a hydroxyl group and an ether structure. Concretely, the solvent is preferably one or more selected from propylene glycol monomethyl ether acetate, cyclohexanone, 2-heptanone, gamma-butyrolactone, propylene glycol monomethyl ether, ethyl lactate. Most preferred is a solvent containing propylene glycol monomethyl ether acetate as securing coating uniformity.

The content of the solvent in the composition of the invention may be suitably optimized depending on the viscosity of the constitutive ingredients except the solvent, the coatability of the composition and the intended thickness of the film to be formed. From the viewpoint of the coatability, the solvent content may be 99% or less by mass of the composition, and, in general, the solvent is not substantively contained in the curable composition of the invention (for example 3% by mass or less). In forming a patter having a thickness of at most 500 nm by a spin coating or the like, the solvent content may be preferably from 20 to 99% by mass, preferably from 40 to 99% by mass, even more preferably from 70 to 98% by mass.

### —Polymer Ingredient—

The composition of the present invention may comprise a polyfunctional oligomer having a larger molecular weight than that of the above-mentioned, other polyfunctional monomer within a range capable of attaining the object of the present invention, for the purpose of further increasing the crosslinking density of the composition. Examples of the photoradical-polymerizable polyfunctional oligomer include various acrylate oligomers such as polyester acrylates, urethane acrylates, polyether acrylates, epoxy acrylates. The amount of the oligomer ingredient to be added to the composition may be preferably from 0 to 30% by mass of the composition except the solvent therein, more preferably from 0 to 20% by mass, even more preferably from 0 to 10% by mass, most preferably from 0 to 5% by mass.

The curable composition of the present invention may comprise any other polymer ingredient for the purpose of enhancing the dry etching resistance, the imprint aptitude and the curability of the composition. The polymer ingredient is preferably a polymer having a polymerizable functional group in the side chain thereof. The weight-average molecular weight of the polymer ingredient is preferably from 2000 to 100000, more preferably from 5000 to 50000, from the viewpoint of the miscibility of the polymer with the polymerizable monomers constituting the composition. The amount of the polymer ingredient to be added may be preferably from 0 to 30% by mass of the composition except the solvent therein, more preferably from 0 to 20% by mass, even more preferably from 0 to 10% by mass, most preferably at most 2% by mass. When the content of the polymer ingredient having a molecular weight of at least 2000 in the composition of the present invention is at most 30% by mass of the composition except the solvent therein, then the patternability of the composition is bettered. From the viewpoint of the patternability of the composition, the resin content therein is preferably as small as possible, and except for the surfactant and other minor additives, preferably, the composition does not comprise any additional resin ingredient.

In addition to the above-mentioned ingredients, the curable composition for imprints of the invention may contain, if desired, UV absorbent, light stabilizer, antiaging agent, plasticizer, adhesion promoter, thermal polymerization initiator, colorant, elastomer particles, photoacid enhancer, photobase generator, basic compound, flowability promoter, defoaming agent, dispersant, etc.

The composition for imprints of the present invention is produced by mixing the above-mentioned ingredients. The ingredients may be mixed and dissolved to prepare the composition, generally at a temperature falling within a range of from 0° C. to 100° C. After the ingredients are mixed, the resulting mixture may be filtered through a filter having a pore size of from 0.003 μm to 5.0 μm, preferably 0.05 μm to 5.0 μm, to give a solution. The filtration may be effected in plural stages, or may be repeated plural times. The solution once filtered may be again filtered. Not specifically defined, the material of the filter may be any one, for example, polyethylene resin, polypropylene resin, fluororesin, nylon resin, etc.

The viscosity of all the ingredients except a solvent of the composition of the present invention is preferably 100 mPa·s or less, more preferably 1 to 70 mPa·s, further more preferably 2 to 5 mPa·s, still more preferably 3 to 30 mPa·s.

### [Patterning Method]

The patterning method (especially micropatterning method) of using the curable composition for imprints of the present invention is described below. The patterning method of the present invention comprises applying the curable composition for imprints of the present invention onto a substrate or a support (base) to form a patterning layer thereon; pressing a mold against the surface of the patterning layer; and irradiating the patterning layer with light, thereby curing the composition of the present invention to form a micropattern.

Here, it is preferable that the curable composition for imprints of the present invention is, after being irradiated with light, further heated and cured. Concretely, the patterning layer comprising at least the composition of the present invention is applied onto a substrate (base or support) and optionally dried to form a layer comprising the composition of the present invention (patterning layer), thereby preparing a pattern acceptor (having the patterning layer formed on the substrate), then a mold is pressed against the surface of the patterning layer of the pattern acceptor to thereby transfer the mold pattern, and the micropatterned layer is cured through photoirradiation. The photoimprint lithography by the patterning method of the present invention may enable lamination and multi-layer patterning, and therefore, may be used in combination with an ordinary thermoimprint.

The curable composition for imprints of the present invention may form a finer micropattern at low cost and with high accuracy by a photoimprint method. Accordingly, the composition of the present invention can form micropatterns heretofore formed by conventional photolithography technology at low cost and with high accuracy. For example, when the composition of the present invention is applied onto a substrate or a support, and the layer comprising the composition is exposed to light, cured, and optionally dried (baked), it thus can be employed as a permanent film of an overcoat layer or an insulating film, and the like for use in liquid-crystal displays (LCD); and the like, and as an etching resist for semiconductor integrated circuits, recording materials, flat panel displays, or the like. In particular, the patterns formed by using the curable composition for imprints of the present invention are excellent in etching property, and can be preferably used as an etching resist in dry etching using fluorocarbon, etc.

In the permanent films (resists for structural members) for use in liquid-crystal displays (LCD) and in production of semiconductor, the resist is preferably prevented from being contaminated as much as possible with metallic or organic ionic impurities in order that the resist does not interfere with the performance of the products. The concentration of the metallic or organic ionic impurities in the curable composition for imprints of the present invention is preferably at most 1000 ppm, more preferably at most 10 ppm, and further more preferably at most 100 ppb.

The patterning method (pattern transferring method) with the curable composition for imprints of the invention is described concretely hereinunder.

In the patterning method of the invention, the composition of the invention is first applied (preferably coated) onto a support to form a patterning layer thereon.

The coating method for applying the curable composition for imprints of the invention onto a substrate may be a well known coating method of, for example, a dip coating method, an air knife coating method, a curtain coating method, a wire bar coating method, a gravure coating method, an extrusion coating method, a spin coating method, a slit scanning method, an inkjet method, etc.

The thickness of the patterning method of the composition of the invention may vary depending on the use thereof, and may be from 0.03 μm to 30 μm or so. The composition may be coated by a multilayer coating. In the case where droplets are applied on a substrate by an inkjet method, the amount of the droplets is preferably 1 pl to 20 pl. The droplets is preferably applied on the substrate at intervals. Between the substrate and the patterning method of the composition of the invention, any other organic layer may be formed, such as a planarizing layer, etc. With that, the patterning layer is not kept indirect contact with the substrate, and therefore, the substrate may be prevented from being contaminated with dust or from being scratched, and the adhesiveness of the patterning layer to the substrate may be enhanced. The pattern to be formed of the composition of the invention may have good adhesiveness to the organic layer, if any, formed on the substrate.

The substrate (base or support) to which the curable composition for imprints of the invention is applied may be selected from various materials depending on its use, including, for example, quartz, glass, optical film, ceramic material, vapor deposition film, magnetic film, reflective film, metal substrate of Ni, Cu, Cr, Fe or the like, paper, SOG (spin on glass), polymer substrate such as polyester film, polycarbonate film or polyimide film, TFT array substrate, PDP electrode plate, glass or transparent plastic substrate, electroconductive substrate of ITO, metal or the like, insulating substrate, semiconductor substrate such as silicon, silicon nitride, polysilicon, silicon oxide or amorphous silicon, which, however, are not limitative. The shape of the substrate is not also specifically defined. It may be tabular or roll. As described below, the substrate may be light-transmissive or non-light-transmissive, depending on the combination thereof with a mold.

Next, in the patterning method of the invention, a mold is pressed against the surface of the patterning layer for transferring the pattern from the mold onto the patterning layer. Accordingly, the micropattern previously formed on the pressing surface of the mold is transferred onto the patterning layer.

The mold material usable in the invention is described. In the photo-imprint lithography with the composition of the invention, a light-transmissive material is selected for at least one of the mold material and/or the substrate. In the photo-imprint lithography applied to the invention, the curable composition for imprints of the invention is applied onto a substrate to form a patterning layer thereon, and a light-transmissive mold is pressed against the surface of the layer, then this is irradiated with light from the back of the mold and the patterning layer is thereby cured. Alternatively, the curable composition for photo-imprints is applied onto a light-transmissive substrate, then a mold is pressed against it, and this is irradiated with light from the back of the substrate whereby the curable composition for photo-imprints can be cured.

The photo-irradiation may be attained while the mold is kept in contact with the layer or after the mold is released. In the invention, preferably, the photo-irradiation is attained while the mold is kept in contact with the patterning layer.

The mold usable in the invention has a transferable pattern formed thereon. The pattern of the mold may be formed, for example, through photolithography, electronic beam lithography or the like by which a pattern may be formed to a desired processing accuracy. In the invention, however, the mold patterning method is not specifically defined.

Not specifically defined, the light-transmissive mold material for use in the invention may be any one having a desired strength and durability. Concretely, its examples include glass, quartz, light-transparent resin such as PMMA or polycarbonate resin, transparent metal deposition film, flexible film of polydimethylsiloxane or the like, photocured film, metal film, etc.

The non-light-transmissive mold to be used in the invention where a light-transmissive substrate is used is not also specifically defined and may be any one having a predetermined strength. Concretely, examples of the mold material include ceramic material, deposition film, magnetic film, reflective film, metal material of Ni, Cu, Cr, Fe or the like, as well as SiC, silicon, silicon nitride, polysilicon, silicon oxide, amorphous silicon, etc. However, these are not limitative. The shape of the mold is not also specifically defined, and may be any of a tabular mold or a roll mold. The roll mold is used especially when continuous transfer in patterning is desired.

The mold for use in the patterning method of the invention may be processed for surface release treatment for the purpose of enhancing the releasability of the curable composition for imprints of the invention from the mold. The mold of the type includes those surface-treated with a silicone-type or fluorine-containing silane coupling agent, for which, for example, commercial release agents such as Daikin's Optool DSX, Sumitomo 3M's Novec EGC-1720 and others are preferred.

In photo-imprint lithography with the composition of the invention, in general, the mold pressure in the patterning method of the invention is preferably at most 10 atmospheres. When the mold pressure is at most 10 atmospheres, then the mold and the substrate are hardly deformed and the patterning accuracy tends to increase. It is also favorable since the pressure unit may be small-sized since the pressure to be given to the mold may be low. The mold pressure is preferably selected from the region capable of securing the mold transfer uniformity, within a range within which the residual film of the curable composition for imprints in the area of mold pattern projections may be reduced.

In the patterning method of the invention, the dose of photo-irradiation in the step of irradiating the patterning layer with light may be sufficiently larger than the dose necessary for curing. The dose necessary for curing may be suitably determined depending on the degree of consumption of the unsaturated bonds in the curable composition for imprints and on the tackiness of the cured film as previously determined.

By using the curable composition for imprints of the present invention, a good imprinting property may be kept, even if pressed under a mold and exposed to light after being applied on a substrate in an environment highly causative of vaporization of the components or contamination from the environment and then allowed to stand, such as being allowed to stand under a reduced pressure (typically at 0.01 MPa or below) or for one minute or longer after the application. When the duration from the application to the mold pressing ranges from 1 to 20 minutes, particularly satisfactory imprinting property may be kept. The effect is much meaningful when the curable composition is applied by an ink-jet process. Even if the duration from the mold pressing to the exposure is shortened, a good mold filling property and a good imprinting property may be kept. More specifically, the curable composition has to be filled into a mold in an appropriate manner within the period from the mold pressing to the exposure, where a poor filling property elongates the time for filling, and a shortened time for filling may result in curing before being appropriately filled. In contrast, the present invention successfully suppress all of the problems, so that a good imprinting property may be kept even if the duration from the mold pressing to the exposure is shorter than 60 seconds, even shorter than 30 seconds, and still even shorter than 10 seconds.

In the photo-imprint lithography applied to the invention, the substrate temperature in photo-irradiation may be room temperature; however, the photo-irradiation may be attained under heat for enhancing the reactivity. In the previous stage of photo-irradiation, preferably, the system is kept in vacuum as effective for preventing contamination with bubbles or contamination with oxygen or for preventing the reduction in reactivity, and as effective for enhancing the adhesiveness of the curable composition for imprints with mold. The system may be subjected to photo-irradiation while still kept in vacuum. In the patterning method of the invention, the vacuum degree in photo-irradiation is preferably from 10⁻¹ Pa to ordinary pressure.

Light to be used for photo-irradiation to cure the curable composition for imprints of the invention is not specifically defined. For example, it includes light and irradiations with a wavelength falling within a range of high-energy ionizing radiation, near-ultraviolet, far-ultraviolet, visible, infrared, etc. The high-energy ionizing radiation source includes, for example, accelerators such as Cockcroft accelerator, Handegraf accelerator, linear accelerator, betatoron, cyclotron, etc. The electron beams accelerated by such an accelerator are used most conveniently and most economically; but also are any other radioisotopes and other radiations from nuclear reactors, such as γ rays, X rays, α rays, neutron beams, proton beams, etc. The UV sources include, for example, UV fluorescent lamp, low-pressure mercury lamp, high-pressure mercury lamp, ultra-high-pressure mercury lamp, xenon lamp, carbon arc lamp, solar lamp, etc. The radiations include microwaves, EUV, etc. In addition, laser rays for use in microprocessing of semiconductors, such as LED, semiconductor laser ray, 248 nm KrF excimer laser ray, 193 nm ArF excimer laser ray and others, are also favorably used in the invention. These lights may be monochromatic lights, or may also be lights of different wavelengths (mixed lights).

In photo-exposure, the light intensity is preferably within a range of from 1 mW/cm² to 50 mW/cm². When the light intensity is at least 1 mW/cm², then the producibility may increase since the photo-exposure time may be reduced; and when the light intensity is at most 50 mW/cm², then it is favorable since the properties of the permanent film formed may be prevented from being degraded owing to side reaction. Also preferably, the dose in photo-exposure is within a range of from 5 mJ/cm² to 1000 mJ/cm². When the dose is less than 5 mJ/cm², then the photo-exposure margin may be narrow and there may occur problems in that the photo-curing may be insufficient and the unreacted matter may adhere to mold. On the other hand, when the dose is more than 1000 mJ/cm², then the composition may decompose and the permanent film formed may be degraded.

Further, in photo-exposure, the oxygen concentration in the atmosphere may be controlled to be less than 100 mg/L by introducing an inert gas such as nitrogen or argon into the system for preventing the radical polymerization from being retarded by oxygen.

In the patterning method of the invention, after the pattern layer is cured through photo-irradiation, if desired, the cured pattern may be further cured under heat given thereto. The method may additionally includes the post-curing step. Thermal curing of the composition of the invention after photo-irradiation is preferably attained at 150 to 280° C., more preferably at 200 to 250° C. The heating time is preferably from 5 to 60 minutes, more preferably from 15 to 45 minutes.

### [Pattern]

The pattern thus formed according to the patterning method of the invention as described in the above can be used as a permanent film (resist for structural members) for use in liquid-crystal displays (LCD) and others, or as an etching resist. After its production, the composition of the invention may be bottled in a container such as a gallon bottle or a coated bottle, and may be transported or stored. In this case, the container may be purged with an inert gas such as nitrogen, argon or the like for preventing the composition therein from being degraded. The composition may be transported or stored at ordinary temperature, but for preventing the permanent film from being degraded, it is preferably transported or stored at a controlled temperature of from −20° C. to 0° C. Needless-to-say, the composition is shielded from light to such a level on which its reaction does not go on.

The pattern formed according to the patterning method of the invention is useful as an etching resist. In case where the composition for imprints of the invention is used as an etching resist, a nano-order micropattern is first formed on a substrate such as a silicon wafer with a thin film of SiO₂ or the like formed thereon, according to the patterning method of the invention. Next, this is etched with hydrogen fluoride in wet etching, or with CF₄ in dry etching, thereby forming a desired pattern on the substrate. The curable composition for imprints of the invention exhibits especially good etching resistance in dry etching.

### Examples

The characteristics of the invention are described more concretely with reference to Production Examples and Examples given below. In the following Examples, the material used, its amount and the ratio, the details of the treatment and the treatment process may be suitably modified or changed not overstepping the scope of the invention. Accordingly, the invention should not be limitatively interpreted by the Examples mentioned below.

### (Preparation of Curable Composition)

Polymerizable monomers and polymerization initiator listed in Table below were mixed, and 4-hydroxy-2,2,6,6-tetramethylpiperidine-1-oxyl free radical (from Tokyo Chemical Industry Co., Ltd.) was added as a polymerization inhibitor so as to adjust the content thereof to 200 ppm (0.02% by mass) relative to the polymerizable monomer. The mixture was filtered through a 0.1-μm tetrafluoroethylene filter, to thereby prepare a curable composition. Values in the Table are expressed in ratio by weight.

TABLE 1

| | Examples | | | | | | | | Comparative Examples | | | | |
|---|---|---|---|---|---|---|---|---|---|---|---|---|---|
| | A1 | A2 | A3 | A4 | A5 | A6 | A7 | A8 | B1 | B2 | B3 | B4 | B5 |
| R-1 | 62 | | | | | | | | 62 | | | | |
| R-2 | | 48 | 47 | 49 | | 49 | 49 | 49 | | 48 | 48 | 48 | 49 |
| R-3 | | | | | 18 | | | | | | | | |
| R-4 | | 48 | 48 | 48 | | 48 | 48 | 48 | | 48 | 48 | 48 | 48 |
| R-5 | | | | | 37 | | | | | | | | |
| R-6 | | | | | 40 | | | | | | | | |
| R-7 | 30 | | | | | | | | 30 | | | | |
| Ax1 | 5 | | | | | | | | | | | | |
| Ax2 | | 1 | | | 2 | | | | | | | | |
| Ax3 | | | 2 | | | | | | | | | | |
| Ax4 | | | | 0.5 | | | | | | | | | |
| Ax5 | | | | | | 0.5 | | | | | | | |
| Ax6 | | | | | | | 0.5 | | | | | | |
| Ax7 | | | | | | | | 0.5 | | | | | |
| X1 | | | | | | | | | 5 | | | | |
| X2 | | | | | | | | | | 1 | | 0.5 | |
| X3 | | | | | | | | | | | 1 | 0.5 | |
| P-1 | 3 | | | | 3 | | | | 3 | | | | |
| P-2 | | 3 | 2 | 3 | | 3 | 3 | 3 | | 3 | 3 | 3 | 3 |

Polymerizable Monomers (Ax)
Ax1: R-1433, from Daikin Industries, Ltd.
Ax2: R-1633, from Daikin Industries, Ltd.
Ax3: synthesized from perfluorobutylethanol and Karenz AOI
(Showa Denko K.K.)
Ax4: synthesized from perfluorohexylethanol and Karenz AOI
(from Showa Denko K.K.)
Ax5: synthesized from a correspondent alcohol compound and
Karenz AOI (from Showa Denko K.K.)
Ax6: F06169D, from AZmax Co.
Ax7: synthesized from F01227HK-F from AZmax Co. and acrylic acid 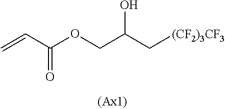 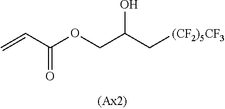 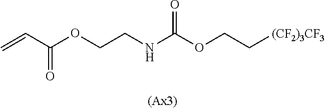 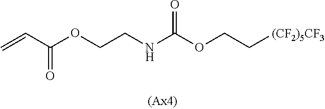 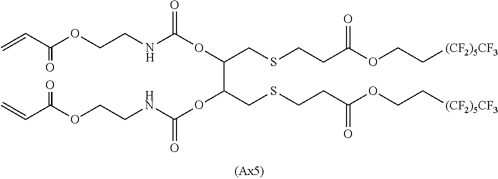 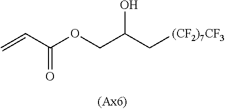 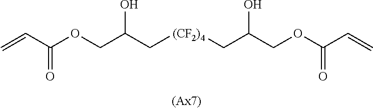
Comparative Compounds
X1: R-1420, from Daikin Industries, Ltd.
X2: R-1620, from Daikin Industries, Ltd.
X3: synthesized from a correspondent epoxy compound and acrylic
acid

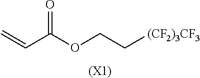

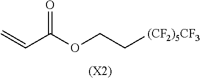

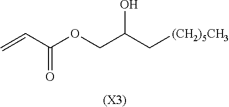

### <Another Polymerizable Monomer>

R-1: benzyl acrylate (Biscoat #160, from Osaka Organic Chemical Industry Ltd.)
R-2: 2-naphthylmethyl acrylate (synthesized from 2-bromomethylnaphthalene and acrylic acid by a general method)
R-3: ethylene glycol diacrylate (from Aldrich)
R-4: m-xylylene diacrylate (synthesized from α,α′-dichloro-m-xylene and acrylic acid by a general method)
R-5: isoboronyl acrylate (IBXA, from Osaka Organic Chemical Industry Ltd.)
R-6: (3-acryloxypropyl)tris(trimethylsiloxy)silane (SIA0210, from Gelest Inc.)
R-7: tricyclodecanedimethanol diacrylate (A-DCP, from Shin-Nakamura Chemical Co., Ltd.)

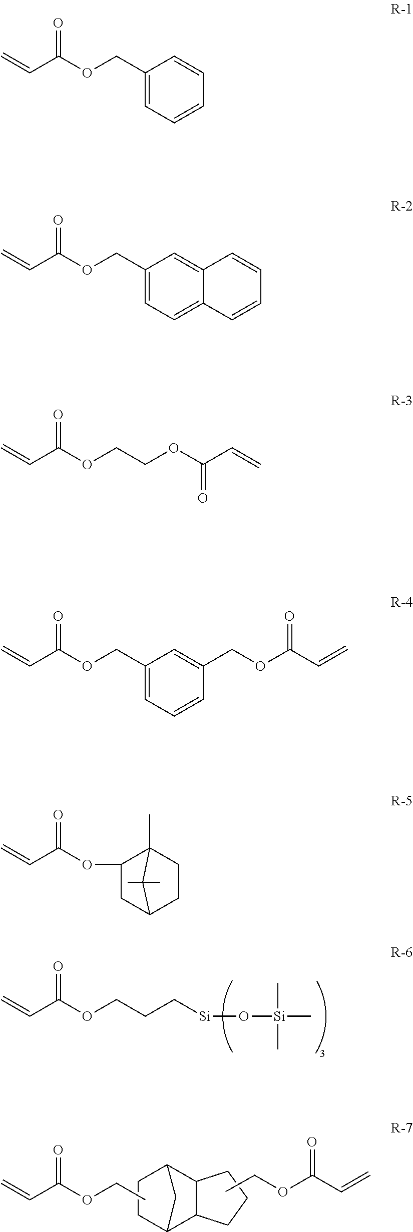

### <Photo-Polymerization Initiators>

P-1: 2-hydroxy-2-methyl-1-phenyl-propane-1-one (Darocur 1173, from BASF)

### P-2:

(2-dimethylamino-2-(4-methylbenzyl)-1-(4-morpholine-4-yl-phenyl)butane-1-one (Irgacure 379EG, from BASF)

### (Evaluation)

The curable compositions obtained in the individual Examples and Comparative Examples were evaluated as described below. Results are shown in Table below.

### <Method of Forming Pattern>

A quartz mold used herein had a rectangular cross-sectional line/space pattern (1/1) with a line width of 30 nm and a groove depth of 60 nm, having the surface of which treated by Optool DSX (from Daikin Industries, Ltd.), and with a line edge roughness of 2.3 nm.

Using the mold, a pattern was formed according to any one of (Condition 1) to (Condition 3) below.

### (Condition 1)

The photo-curable composition was jetted using an ink-jet printer from Fujifilm Dimatix, Inc., onto a silicon wafer by controlling the timing of jetting so as to form a 450-μm pitch orthogonal matrix pattern while setting the amount of jetting to 8 pl per nozzle. Five minutes after the jetting, the mold was placed on the photo-curable composition at 25° C. under 1 atm, and one minute after the composition was irradiated using a mercury lamp at an exposure energy of 300 mJ/cm². After the exposure, the mold was released to thereby obtain a pattern.

### (Condition 2)

The pattern was obtained similarly under Condition 1, except that the duration from the placement of the mold to the exposure was set to 5 seconds.

### (Condition 3)

The pattern was obtained similarly under Condition 1, except that the mold was placed in an environment under a reduced pressure of 0.1 atm, and that the duration from the placement of the mold to the exposure was set to 5 seconds.

### <Evaluation of Pattern>

The obtained patterns were observed under a scanning electron microscope, and geometry and defects of the patterns were evaluated as follow.

### (Evaluation of Geometry)

A: Rectangular cross-sectional pattern highly conforming to the mold pattern.
B: Pattern rounded at the top.
C: Pattern rounded at the top, and shortened in height.

### (Evaluation of Defects)

Defects of the pattern such as separation, chipping, and collapse were observed.

a: No pattern defect observed.
b: Defects partially observed in an area of smaller than 5% of the total pattern area.
c: Defects observed in an area of 5% or more of the total pattern area.
<Line Edge Roughness after Dry Etching (LER)>

The substrate with the pattern obtained by the method of forming a pattern under Condition 3 was dry-etched using a dry etcher from Hitachi High-Technologies Corporation, in an Ar/CF₄/O₂ gas plasma, and a 5-μm-long, defect-free portion of the obtained line pattern was observed under a length-measurement SEM at 50 points, so as to determine distance of the actual edge away from the designed position of reference line, standard deviation, and 3G. Note that the smaller values mean better results of line edge roughness.

TABLE 2

| | Condition 1 | | Condition 2 | | Condition 3 | | LER (nm) after |
|---|---|---|---|---|---|---|---|
| | Geometry | Defects | Geometry | Defects | Geometry | Defects | dry etching |
| Example A1 | A | a | A | a | A | a | 3.2 |
| Example A2 | A | a | A | a | A | a | 2.7 |
| Example A3 | A | a | B | a | A | a | 2.8 |
| Example A4 | A | a | B | a | A | a | 2.6 |
| Example A5 | A | a | A | a | A | a | 3.6 |
| Example A6 | A | a | B | b | A | b | 4.0 |
| Example A7 | A | a | A | b | A | b | 3.6 |
| Example A8 | A | a | A | b | A | b | 3.5 |
| Comparative | A | b | B | b | B | c | 5.6 |
| Example B1 | | | | | | | |
| Comparative | A | b | B | b | B | c | 5.8 |
| Example B2 | | | | | | | |
| Comparative | B | c | B | c | B | c | 5.6 |
| Example B3 | | | | | | | |
| Comparative | A | b | B | b | B | c | 5.5 |
| Example B4 | | | | | | | |
| Comparative | B | c | B | c | B | c | 5.0 |
| Example B5 | | | | | | | |

Examples using the curable composition of the present invention were found to give excellent pattern geometry, less defects, and small line edge roughness after etching, even when the patterns were formed under Conditions 2 and 3 characterized by high throughput. On the other hand, Comparative Examples were found to be poor in any of the performances of pattern geometry, defects and line edge roughness after dry etching.

The present disclosure relates to the subject matter contained in Japanese Patent Application No. 049095/2011 filed on Mar. 7, 2011, which is expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A curable composition for imprints, comprising at least one species of polymerizable monomer(s) (A), and a photo-polymerization initiator (B), wherein the polymerizable monomer (A) contains a polymerizable monomer (Ax) having a hydrogen-bondable group and fluorine-containing group(s).

2. The curable composition for imprints according to claim 1, wherein the polymerizable monomer (Ax) has one fluorine-containing group.

3. The curable composition for imprints according to claim 1, wherein the fluorine-containing group owned by the polymerizable monomer (Ax) is a perfluoroalkyl group having 4 to 6 carbon atoms.

4. The curable composition for imprints according to claim 1, wherein the hydrogen-bondable group owned by the polymerizable monomer (Ax) has a N—H bond and/or an O—H bond.

5. The curable composition for imprints according to claim 1, wherein the polymerizable monomer (Ax) has one polymerizable group.

6. The curable composition for imprints according to claim 1, wherein the polymerizable monomer (Ax) has an acryloyloxy group (CH₂═CHC(═O)O—).

7. The curable composition for imprints according to claim 1, wherein the polymerizable monomer (A) comprises a polymerizable monomer different from the polymerizable monomer (Ax).

8. The curable composition for imprints according to claim 7, wherein the polymerizable monomer different from the polymerizable monomer (Ax) is a (meth)acrylate comprising at least one of aromatic group, alicyclic hydrocarbon group and Si atom.

9. The curable composition for imprints according to claim 1, wherein the content of the polymerizable monomer (Ax) is 0.2 to 10% by mass of the total polymerizable monomer components.

10. The curable composition for imprints according to claim 1, further comprising a polymerization inhibitor.

11. The curable composition for imprints according to claim 1, wherein the fluorine-containing group includes at least one of partial structures represented by the formula (I-1) or (I-2):
—X—Rf (I-1)
—X—Rf—X— (I-2)
wherein X represents an alkylene group having 1 to 6 carbon atoms and Rf represents a fluoroalkyl group or fluoroalkyl ether group.

12. The curable composition for imprints according to claim 1, wherein the fluorine-containing group includes at least one of partial structures represented by the formula (II-1) or (II-2):
—X—CₙF₂ₙ₊₁ (II-1)
—X—CₙF₂ₙ—X— (II-2)
wherein X represents an alkylene group having 1 to 6 carbon atoms and n represents an integer from 1 to 8.

13. The curable composition for imprints according to claim 1, wherein the hydrogen-bondable group has a partial structure represented by —OH, —C(═O)OH, —SO₃H, —NH—, —NH₂, —NHC(O)—, —NHC(O)O—, —NHC(O)NH—, —SO₂NH—, —SO₂NHC(═O)— or —SO₂NHSO₂—.

14. The curable composition for imprints according to claim 1, wherein the polymerizable monomer (A) is selected from compounds represented by any one of the following formulae: 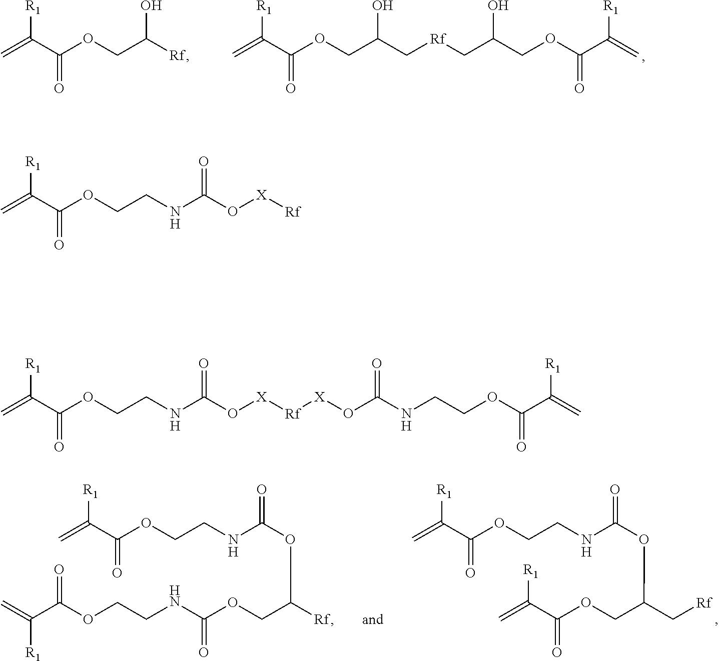
wherein R₁ independently represents a hydrogen atom, halogen atom, alkyl group or cyano group, Rf represents a fluorine-containing group and X represents an alkylene group having 1 to 6 carbon atoms.

15. The curable composition for imprints according to claim 14, wherein Rf is a perfluoroalkyl group.

16. The curable composition for imprints according to claim 1, wherein the polymerizable monomer (A) has a molecular weight of 300 to 2000.

17. The curable composition for imprints according to claim 7, wherein the content of the polymerizable monomer different from the polymerizable monomer (Ax) is 20 to 70% by mass of the total polymerizable monomer components.

18. A method of forming a pattern, comprising:
forming a pattern-forming layer by applying the curable composition for imprints according to claim 1, onto a base;
pressing a mold against the surface of the pattern-forming layer; and
irradiating light to the pattern-forming layer.

19. The method of forming a pattern according to claim 18, wherein the curable composition for imprints is applied onto the base by an ink-jet process.

20. A pattern obtained by the method of forming a pattern according to claim 18.
